(19) United States
(12) Patent Application Publication
(10) Pub. No.: US 2012/0066127 A1
(43) Pub. Date: Mar. 15, 2012

(54) OVERAGE SERVICE SUBJECT TO CONDITION

(75) Inventors: Tamara S. Kingston, Peoria, AZ (US); John Franklin Tuders, Harrisburg, NC (US); Ross Matthew Feldman, Matthews, NC (US); Marc Lance Warshawsky, Davidson, NC (US); Erik Stephen Ross, Charlotte, NC (US); Elbert Lee Whitler, Webster Groves, MO (US); Mark D. Zanzot, Huntersville, NC (US); Ketil Bjugan, Charlotte, NC (US); Scott Mastbrook, Charlotte, NC (US); William Sydney Ivey, Charlotte, NC (US); Mark Allan Nelson, Waxhaw, NC (US); Brenda Lisbeth Smyth, Fenton, MO (US); Doris Maria Garrett, Walnut Creek, CA (US); Jonathan H. Tucker, Charlotte, NC (US); Catherine Stokes Pullen, Mount Holly, NC (US); Paul Ronald DeKoster, Matthews, NC (US)

(73) Assignee: BANK OF AMERICA CORPORATION, Charlotte, NC (US)

(21) Appl. No.: 13/033,510

(22) Filed: Feb. 23, 2011

Related U.S. Application Data
(63) Continuation-in-part of application No. 12/879,866, filed on Sep. 10, 2010.
(60) Provisional application No. 61/416,652, filed on Nov. 23, 2010.
(60) Provisional application No. 61/436,196, filed on Jan. 26, 2011.

(51) Int. Cl. G06Q 40/00

(52) U.S. Cl. 705/44

(57) ABSTRACT

In general terms, embodiments of the present invention relate to methods and apparatuses for providing an overage service subject to one or more predetermined conditions. For example, in some embodiments, a method is provided that includes: (a) receiving, from a holder of an account, consent to a future overage, where the future overage is a result of a future overage transaction involving the account, and where the consent is valid only if a predetermined condition is met; (b) receiving transaction information associated with a transaction, where the transaction involves the account, and where the transaction was initiated after the receiving the consent; (c) determining, based at least partially on the transaction information, that the account will incur an overage as a result of the transaction; (d) determining that the predetermined condition is met and/or that the holder's consent is valid for the transaction; and (e) authorizing the transaction based at least partially on receiving the consent, determining that the holder's consent is valid for the transaction, and/or determining that the predetermined condition is met.

### CROSS-REFERENCE TO RELATED APPLICATIONS

The present application is a continuation-in-part application of, and claims priority to, U.S. patent application Ser. No. 12/879,866, which was filed on Sep. 10, 2010, and is entitled “Service Participation Acknowledgment System,” and which is incorporated by reference herein in its entirety. The present application also claims priority to U.S. Provisional Patent Application No. 61/416,652, which was filed on Nov. 23, 2010, and is entitled “Overage Communication Systems,” and which is incorporated by reference herein in its entirety. The present application further claims priority to U.S. Provisional Patent Application No. 61/436,196, which was filed on Jan. 26, 2011, and is entitled “Overage Communication Systems,” and which is incorporated by reference herein in its entirety.

### BACKGROUND

Financial institution customers are constantly looking for new and useful ways to better manage their finances. This is particularly so given that most of today's financial institution customers have multiple financial accounts and the consequences associated with mismanaging or forgetting about any one of them can lead to unexpected or unwanted outcomes. For example, a customer may overdraft his checking account and incur a related overdraft fee by engaging in a transaction that he mistakenly believes his account can cover. Accordingly, there is a need to provide methods and apparatuses that help financial institution customers manage their finances in ways that avoid or reduce unexpected or unwanted outcomes.

### SUMMARY OF SELECTED EMBODIMENTS OF THE PRESENT INVENTION

In light of the foregoing background, the following presents a simplified summary of the present disclosure in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

In general terms, embodiments of the present invention relate to methods and apparatuses for providing an overage service (e.g., overdraft service, over limit service, etc.) subject to one or more predetermined conditions (e.g., limitations, rules, requirements, etc.). For example, in some embodiments, a holder of an account can preapprove, agree to, and/or otherwise consent to using an overdraft service to complete a future overdraft transaction involving the account, where the holder's consent is valid only if a predetermined condition is met. In some embodiments, the predetermined condition relates to the future overdraft transaction, such that the holder's consent is valid only if the future overdraft transaction is initiated and/or otherwise occurs during a predetermined period of time (e.g., during the day in which the holder gave his consent, during the week after the holder gave his consent, etc.). In other embodiments, the predetermined condition is such that the holder's consent is valid only if the transaction amount associated with the future overdraft transaction is greater than a predetermined amount (e.g., $50, $250, etc.). In accordance with some embodiments, the holder or a financial institution can select the one or more terms of the predetermined condition.

Of course, in addition to attaching one or more predetermined conditions to the holder's consent, embodiments of the present invention also enable the holder to consent to one or more overage transactions before those overage transactions actually occur. It will be understood that account holders may have a financial incentive to consent to one or more future overage transactions before those overage transaction(s) actually occur. For example, in some embodiments, a regular overage fee associated with an overage transaction may be $35 if the holder consents at the time he engages in that overage transaction, but the overage fee may be only $10 if the holder consents in advance. Of course, there may be other incentives as well. For example, in some embodiments, by consenting to a future overage transaction before that transaction is initiated, the holder may not be required to provide his consent at the time of the transaction, which may spare the holder of any public embarrassment, annoyance, and/or hassle associated with providing his consent and/or being notified of the overage and/or overage fee during the transaction.

In more general terms, some embodiments of the present invention provide a method that includes: (a) receiving, from a holder of an account, consent to a future overage, where the future overage is a result of a future overage transaction involving the account, and where the consent is valid only if a predetermined condition is met; (b) receiving transaction information associated with a transaction, where the transaction involves the account, and where the transaction was initiated after the receiving the consent; (c) determining, using a processor and based at least partially on the transaction information, that the account will incur an overage as a result of the transaction; (d) determining that the predetermined condition is met; and (e) authorizing the transaction based at least partially on the determining that the predetermined condition is met.

In some embodiments of the method, the predetermined condition relates to the future overage transaction, such that the consent is valid only if the future overage transaction is initiated during a predetermined period of time, and the transaction is initiated during the predetermined period of time. Additionally or alternatively, in some embodiments of the method, the predetermined condition relates to the future overage transaction, such that the consent is valid only for a predetermined number of future overage transactions involving the account, and where the transaction constitutes an overage transaction that is less than the predetermined number.

In some embodiments of the method, the predetermined condition relates to the future overage, such that the consent is valid only if the amount of the future overage is greater than a predetermined amount, and where the amount of the overage is greater than the predetermined amount. Additionally or alternatively, in some embodiments of the method, the predetermined condition relates to the future overage transaction, such that the consent is valid only if the transaction amount of the future overage transaction is greater than a predetermined amount, and where the transaction amount of the transaction is greater than the predetermined amount.

In some embodiments of the method, the predetermined condition relates to the future overage transaction, such that the consent is valid only if the future overage transaction involves a predetermined type of merchant, and where the transaction involves the predetermined type of merchant. Additionally or alternatively, in some embodiments of the method, the predetermined condition relates to the future overage transaction, such that the consent is valid only if the future overage transaction involves a predetermined type of channel, and where the transaction involves the predetermined type of channel.

In some embodiments of the method, the predetermined condition relates to the future overage transaction, such that the consent is valid only if the future overage transaction involves a merchant associated with a predetermined merchant category code, and where the transaction involves a merchant associated with the predetermined merchant category code. Additionally or alternatively, in some embodiments of the method, the predetermined condition relates to the type of the future overage transaction, such that the consent is valid only if the future overage transaction includes a predetermined transaction type, and where the transaction includes the predetermined transaction type.

In some embodiments, the method further includes: (a) prompting the holder to select the predetermined condition; and (b) receiving information indicating that the holder has selected the predetermined condition, where the receiving the information occurs before the receiving the transaction information. Additionally or alternatively, in some embodiments, the method further includes: (a) determining that the available balance or available credit for the account has fallen below a predetermined threshold; and (b) prompting the holder to consent to the future overage based at least partially on the determining that the available balance or available credit has fallen below the predetermined threshold, where the prompting the holder occurs before the receiving the consent.

In some embodiments, the method further includes: (a) assessing the account an overage fee based at least partially on determining that the account settled negative at the end of the day in which the transaction occurred; and/or (b) determining not to assess the account an overage fee based at least partially on determining that the account settled non-negative at the end of the day in which the transaction occurred. Additionally or alternatively, in some embodiments, the method further includes: (a) receiving, from a second holder of a second account, second consent to a second future overage, where the second future overage is a result of a second future overage transaction involving the second account, and where the second consent is valid only if a second predetermined condition is met; (b) receiving second transaction information associated with a second transaction, where the second transaction involves the second account, and where the second transaction was initiated after the receiving the second consent; (c) determining, based at least partially on the second transaction information, that the second account will incur a second overage as a result of the second transaction; (d) determining that the second predetermined condition is not met; and (e) declining the second transaction based at least partially on the determining that the second predetermined condition is not met.

In some embodiments, the method further includes storing information associated with the predetermined condition in an account profile associated with the account, where the account profile is stored in a datastore. In some of these embodiments, the determining that the predetermined condition is met is based at least partially on comparing the transaction information received to the information associated with the predetermined condition in the account profile.

As another example, other embodiments of the present invention provide an apparatus that includes: (a) a first communication interface configured to receive, from a holder of an account and via a telecommunications network, consent to a future overage, where the future overage is a result of a future overage transaction involving the account, and where the consent is valid only if a predetermined condition is met; (b) a second communication interface configured to receive, via a payment network, transaction information associated with a transaction, where the transaction involves the account, a transaction machine, and the holder of the account, and where the transaction was initiated after the first communication interface receives the consent; and (c) a processor operatively connected to the first communication interface and the second communication interface, and configured to: (i) determine, based at least partially on the transaction information, that the account will incur an overage as a result of the transaction; (ii) determine that the predetermined condition is met; and (iii) authorize the transaction based at least partially on the processor determining that the predetermined condition is met.

In some of embodiments of the apparatus, the telecommunications network is a telephone network. Additionally or alternatively, in some embodiments, the apparatus further includes a memory device operatively connected to the processor and configured to store information associated with the predetermined condition (e.g., one or more terms of the predetermined condition, etc.) in an account profile associated with the account. In some of these embodiments, the processor determines that the predetermined condition is met is based at least partially on comparing the transaction information received to the information associated with the predetermined condition in the memory device.

As still another example, some embodiments of the present invention provide a computer program product having a non-transitory computer-readable medium. In some embodiments, the non-transitory computer-readable medium includes one or more computer-executable program code portions that, when executed by a computer, cause the computer to: (a) receive, from a holder of an account, consent to a future overage, where the future overage is a result of a future overage transaction involving the account, and where the consent is valid only if a predetermined condition is met; (b) receive transaction information associated with a transaction, where the transaction involves the account, and where the transaction was initiated after the computer receives the consent; (c) determine, based at least partially on the transaction information, that the account does not have sufficient funds or credit to complete the transaction; (d) determine that the predetermined condition is met; and (e) provide funds or credit sufficient to complete the transaction based at least partially on the computer determining that the predetermined condition is met.

In some embodiments of the computer program product, the one or more computer-executable program code portions, when executed by the computer, cause the computer to provide the funds or credit sufficient to complete the transaction by providing only the minimum amount of funds or credit needed to complete the transaction. In other embodiments, the one or more computer-executable program code portions, when executed by the computer, cause the computer to provide the funds or credit sufficient to complete the transaction by crediting the account with the funds or the credit sufficient to complete the transaction. In still other embodiments of the computer program product, the transaction involves a counterparty, and the one or more computer-executable program code portions, when executed by the computer, cause the computer to provide the funds or credit sufficient to complete the transaction by providing the counterparty with the funds or credit sufficient to complete the transaction.

As yet another example, some embodiments of the present invention provide a method that includes: (a) receiving, from a holder of an account, preapproval to use an overage service to complete one or more future overage transactions, where the one or more future overage transactions involve the account and occur during a predetermined period of time; (b) receiving transaction information associated with a transaction, where the transaction involves the account, and where the transaction was initiated after the receiving the preapproval; (c) determining, using a processor and based at least partially on the transaction information, that the account does not have sufficient funds or credit to complete the transaction; (d) determining that the holder's preapproval covers the transaction based at least partially on determining that the transaction has occurred during the predetermined period of time; and (e) using an overage service to complete the transaction based at least partially on the determining that the holder's preapproval covers the transaction.

In some embodiments of the method, the predetermined period of time includes the period of time after the holder gave his preapproval and before the end of the day in which the holder gave his preapproval. In other words, in such embodiments, the holder “consents for the day.” In some of these embodiments, the holder's preapproval covers only a limited number of the future overage transactions that occur later in the day. For example, in some embodiments, the holder's preapproval covers only a predetermined number of future overage transactions involving the account. As another example, in some embodiments, the holder's preapproval covers only those future overage transactions that involve an ATM.

### BRIEF DESCRIPTION OF THE DRAWINGS

Having thus described some embodiments of the present invention in general terms, reference will now be made to the accompanying drawings, wherein:

FIG. 1 is a flow diagram illustrating a general process flow for providing an overage service subject to a predetermined condition, in accordance with an embodiment of the present invention;

FIG. 2 is a flow diagram illustrating a more-detailed process flow for providing an overage service subject to a customer-selected, predetermined condition, in accordance with an embodiment of the present invention;

FIG. 3 is a block diagram illustrating technical components of a system for providing an overage service subject to one or more predetermined conditions, in accordance with an embodiment of the present invention;

FIG. 4 is a mixed block and flow diagram of a system for providing an overdraft service subject to a predetermined time condition, in accordance with an embodiment of the present invention; and

FIG. 5 is a mixed block and flow diagram of a system for providing an over limit service subject to a predetermined transaction amount condition, in accordance with an embodiment of the present invention.

### DETAILED DESCRIPTION OF EMBODIMENTS OF THE PRESENT INVENTION

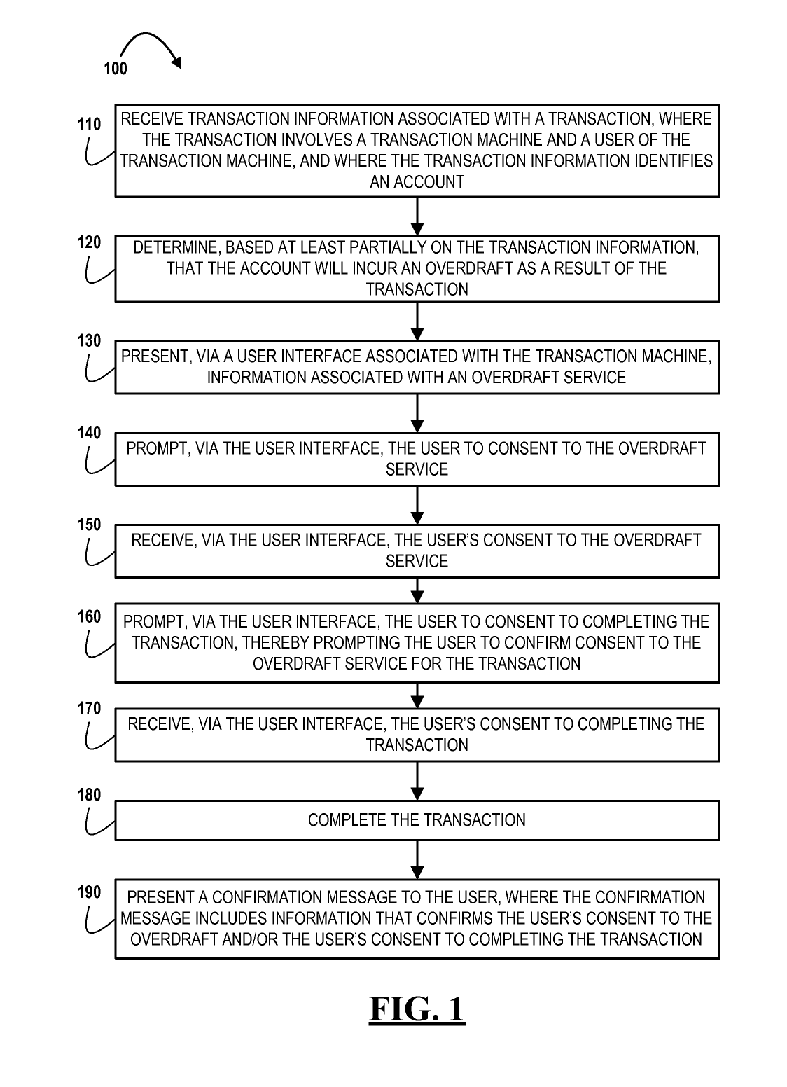

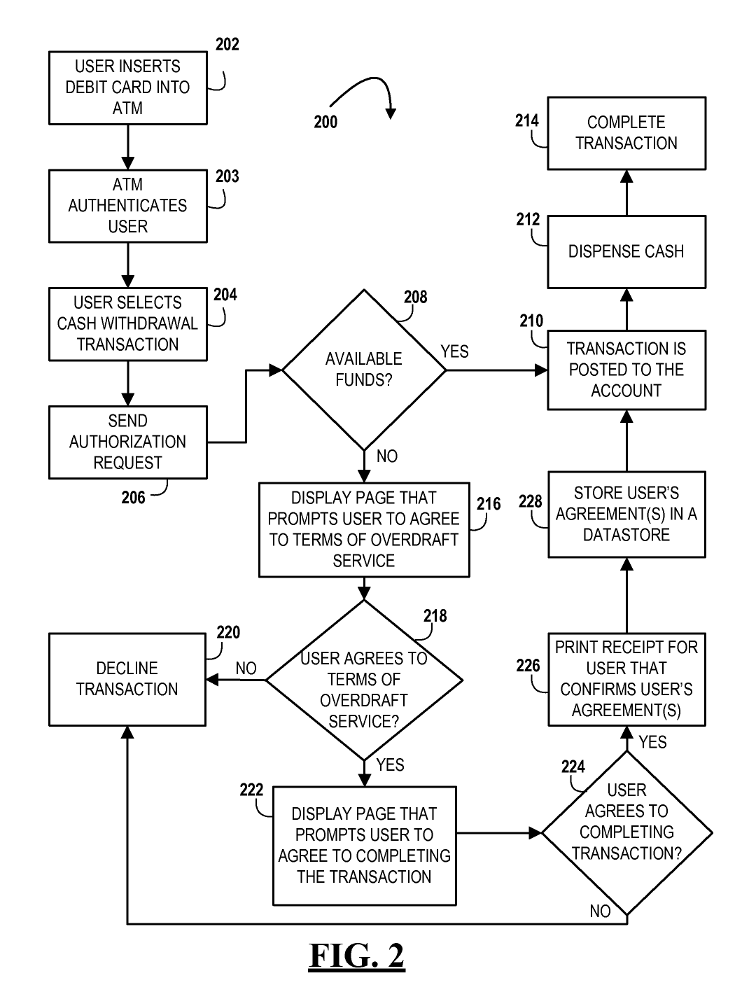

Referring now to FIG. 1, a general process flow 100 for providing an overage service subject to a predetermined condition is provided, in accordance with an embodiment of the present invention. In some embodiments, the process flow 100 is performed by an apparatus (i.e., one or more apparatuses) having hardware and/or software configured to perform one or more portions of the process flow 100. In such embodiments, as represented by block 110, the apparatus is configured to receive, from a holder of an account (e.g., deposit account, credit account, etc.), consent to a future overage, where the future overage is a result of a future overage transaction involving the account, and where the consent is valid only if a predetermined condition is met. As represented by block 120, the apparatus is further configured to receive transaction information associated with a transaction, where the transaction involves the account, the holder, and a transaction machine (e.g., a POS device, automated teller machine (ATM), personal computer, self-checkout machine, etc.), and where the transaction was initiated after the apparatus receives the holder's consent to the future overage. As represented by block 130, the apparatus is also configured to determine, based at least partially on the transaction information, that the account will incur an overage (e.g., be overdrawn, go over limit, etc.) as a result of the transaction. Also, as represented by block 140, the apparatus is configured to determine that the predetermined condition is met and/or that the holder's consent is valid for (e.g., covers) the transaction. Thereafter, as represented by block 150, the apparatus is configured to authorize the transaction based at least partially on receiving the holder's consent, determining that the predetermined condition is met, and/or determining that the holder's consent is valid for the transaction.

For simplicity, it will be understood that the portion of the process flow represented by block 130 is sometimes referred to herein as the “overage determination.” Also for simplicity, the portion of the process flow 100 represented by block 140 is sometimes referred to herein as the “condition determination.” Further, the phrase “overage transaction” is sometimes used herein to refer to a transaction that, if completed, would cause the account to incur an overage (e.g., incur an overdraft, go over a credit limit, etc.).

In some embodiments, the term “determine” is meant to have one or more of its ordinary meanings (i.e., its ordinary dictionary definition(s)), but in other embodiments, the term “determine” is meant to have one or more of the ordinary meanings of one or more of the following terms: decide, conclude, verify, ascertain, find, discover, learn, calculate, observe, read, and/or the like. Also, in some embodiments, the term “via,” as used herein, is meant to have one or more of its ordinary meanings, but in other embodiments, the term “via” is meant to have one or more of the ordinary meanings of one or more of the following terms and/or phrases: from, through, per, with the assistance of, by way of, and/or the like. Further, in some embodiments, the phrase “based at least partially on” is meant to have one or more of its ordinary meanings, but in other embodiments, the phrase “based at least partially on” is meant to have one or more of the ordinary meanings of one or more of the following terms and/or phrases: in response to, because of, after, as a result of, and/or the like.

As used herein, the phrase “future overage transaction” generally refers to a transaction that: (a) is initiated, performed, engaged in, completed, and/or otherwise occurs in the future; and (b) if completed, will result in an overage (i.e., a “future overage”). It will be understood that a future overage transaction refers to a potential transaction that has not yet occurred and may never occur; however, if the future overage transaction does occur, it will result in an overage. Also, as used herein, the phrase “overage fee” generally refers to the one or more fees (e.g., fees, charges, other penalties, etc.) typically associated with incurring an overage (e.g., overdraft, over limit amount, etc.). Thus, the phrase “future overage fee” generally refers to one or more overage fees associated with incurring a “future overage,” which itself results from a “future overage transaction.”

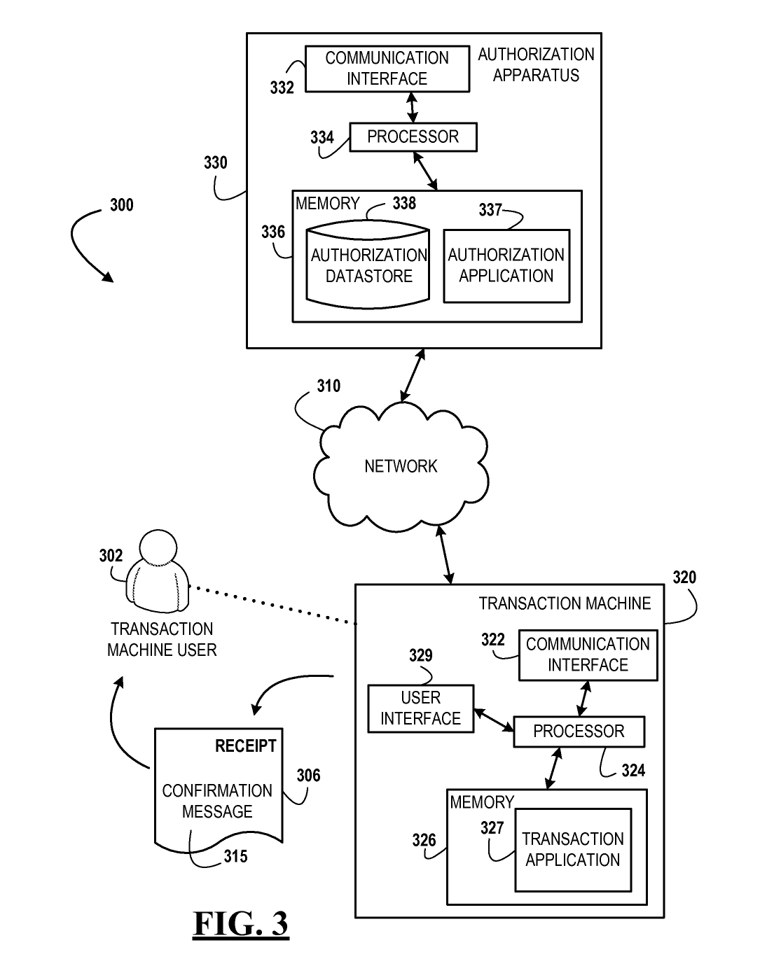

It will also be understood that the apparatus having the process flow 100 can include one or more separate and/or different apparatuses. For example, in some embodiments, one apparatus (e.g., the overage preapproval machine 320 described in connection with FIG. 3, etc.) is configured to perform the portion of the process flow 100 represented by block 110, and a second apparatus (e.g., the authorization apparatus 330, etc.) is configured to perform the portions represented by blocks 120-150. As still another example, in some embodiments, a single apparatus (e.g., the authorization apparatus 330) is configured to perform each and every portion of the process flow 100. It will also be understood that, in some embodiments, a transaction machine (e.g., the overage preapproval machine 320, personal computer 301, POS device 303, ATM 304, etc.) is configured to perform one or more (or all) of the portions of the process flow 100, and that in some embodiments, that transaction machine includes, is included in, and/or is embodied as the transaction machine referred to in block 110.

Regarding block 110, the future overage transaction and the future overage have not yet occurred at the time the holder's consent to the future overage is given and/or received. However, it will be understood that the transaction referred to in block 120 represents that future overage transaction, and the overage referred to in block 130 represents that future overage. In other words, the holder first provides consent to a future overage, as represented by block 110, and then later incurs that future overage by engaging in the transaction referred to in block 120. In this way, the holder can preapprove and/or consent in advance to one or more overages and/or overage transactions that have not yet occurred, so that that the holder does not have to approve and/or consent to those one or more overages and/or overage transactions when they actually do occur. Advantageously, this may spare the holder of any public embarrassment, annoyance, and/or hassle associated with providing his consent and/or being notified of the overage and/or overage fee during the transaction.

As used herein, the phrase “consent to the future overage” is meant to be understood in its broadest sense. For example, in some embodiments, the phrase “consent to the future overage” means consent to: (a) incurring the future overage (e.g., the account and/or the holder incurring the future overage, etc.); (b) incurring an overage fee associated with the future overage (e.g., at the time the future overage is incurred and/or at the end of the day in which the future overage is incurred if the account settles negative at the end of the day, etc.); (c) one or more terms of an overage service (discussed in more detail below); (d) using an overage service to cover the future overage and/or to complete the future overage transaction; (e) incurring an overage fee associated with using the overage service to cover the future overage and/or to complete the future overage transaction; and/or the like.

Regarding blocks 110 and 140, in some embodiments, the holder's consent is subject to one or more predetermined conditions. In accordance with some embodiments, a predetermined condition includes one or more terms that define the predetermined condition and/or how the predetermined condition can be met. For example, in some embodiments, the predetermined condition relates to the future overage transaction, such that the consent is valid only if the future overage transaction is initiated during a predetermined period of time (e.g., during a predetermined minute, hour, day, week, month, year, etc.). In other words, the one or more terms of the predetermined condition define that the predetermined condition is met if the future overage transaction is initiated during the predetermined period of time. Thus, in such embodiments, if the apparatus determines that the transaction referred to in block 120 is initiated during the predetermined period of time, then the apparatus will determine that the predetermined condition is met. As a specific example, in some embodiments, the holder's consent is valid only if the future overage transaction is initiated (and/or otherwise occurs) during the month of March. As another example, in some embodiments, the holder's consent is valid only if the future overage transaction is initiated (and/or otherwise occurs) sometime in the week after the holder gave his consent. As still another example, in some embodiments, the holder's consent is valid only if the future overage transaction is initiated during the same day that the holder gave his consent (e.g., when the holder “consents for the day,” etc.).

In other embodiments, the predetermined condition is such that the consent is valid only for a predetermined number of future overage transactions involving the account (e.g., within a predetermined period of time or over an indefinite period of time). In other words, the one or more terms of the predetermined condition place a limit on the number of overage transactions in which the account can engage. For example, in some embodiments, the holder's consent may be valid for only five overage transactions (but no more than five). In such embodiments, if the apparatus determines that the transaction referred to in block 120 constitutes the sixth overage transaction incurred by the account since the holder's consent was received, then the apparatus will not authorize the transaction. However, in such embodiments, if the apparatus determines that the transaction referred to in block 120 constitutes, for example, the second overage transaction since the holder's consent was received, then the apparatus will authorize the transaction. In other words, in some embodiments, if the predetermined condition is such that the consent is valid only for a predetermined number of future overage transactions, the predetermined condition will be met if the transaction referred to in block 120 is less than and/or within that predetermined number.

In some embodiments, the predetermined condition relates to the amount of the future overage, such that the consent is valid only if the amount of the future overage is less than, greater than, or equal to a predetermined amount. For example, in some embodiments, the holder's consent may be valid only if the overage amount is greater than $50 because, for example, the holder does not want to pay an overage fee for incurring a relatively small overage (e.g., the holder does not want to pay a $35 overdraft fee for overdrafting his account by $5, etc.). In such embodiments, if the apparatus determines that the amount of the overage referred to in block 130 is less than the predetermined amount of $50, then the apparatus will determine that the predetermined condition is not met and/or will decline the transaction.

In some embodiments, the predetermined condition relates to the transaction amount of the future overage transaction, such that the consent is valid only if the transaction amount of the future overage transaction is greater than, less than, or equal to a predetermined amount (e.g., selected by the holder, provided for the holder, etc.). For example, in some embodiments, the holder may preapprove only those future overage transactions having transaction amounts greater than $50. In such embodiments, the holder may not want to engage in an overage transaction (and incur an overage fee) if that overage transaction involves a relatively small and/or discretionary purchase (e.g., the holder does not want to incur a $35 overdraft fee for purchasing a $10 item, etc.). However, the customer may want to engage in an overage transaction if that overage transaction involves a relatively large and/or an emergency and/or non-discretionary purchase (e.g., the holder may want to incur a $35 overdraft fee in order to make his $900 monthly mortgage payment, etc.).

In still other embodiments, the predetermined condition is such that the holder's consent is valid only if the future overage transaction involves a predetermined merchant and/or type of merchant, a predetermined channel and/or type of channel, a predetermined transaction and/or type of transaction, and/or the like. For example, in some embodiments, the predetermined condition is such that the holder's consent is valid only if the future overage transaction involves a predetermined telephone company (e.g., AT&T®, etc.) and/or any telephone company. As another example, in some embodiments, the predetermined condition is such that the holder's consent is valid only if the future overage transaction involves one or more predetermined merchant category codes (e.g., “5411” for grocery supermarkets, “5814” for fast food restaurants, “5541” for service stations, etc.). As still another example, in some embodiments, the predetermined condition is such that the holder's consent is valid only if the future overage transaction is performed at and/or otherwise involves a predetermined ATM (e.g., the ATM at the intersection of 5th and College in Charlotte, N.C., etc.) and/or any ATM. As yet another example, in some embodiments, the predetermined condition is such that the holder's consent is valid only if the future overage transaction involves the holder's monthly mortgage payment, regular student loan payment, and/or any other type of loan payment.

It will be understood that the condition referred to in block 110 is a “predetermined condition” because that condition is inputted, chosen, set, and/or otherwise selected before or at the time the holder indicates his consent to the future overage. Additionally or alternatively, in other embodiments, the condition is a “predetermined condition” because that condition is selected before the future overage transaction relating to the predetermined condition is actually initiated and/or otherwise actually occurs. For example, in accordance with such embodiments, the condition referred to in block 110 is a “predetermined condition” because it is selected before the overage transaction referred to in block 120 is initiated and/or otherwise occurs.

In some embodiments, the customer selects and/or provides the predetermined condition and/or the one or more terms thereof. However, in other embodiments, the predetermined condition and/or its one or more terms are selected for, and/or provided to, the customer by, for example, a financial institution. Also, it will be understood that the holder's preapproval and/or consent can be subject to more than one predetermined condition. For example, in some embodiments, the holder's preapproval covers one or more future overage transactions only if each of those one or more future overage transactions: (a) occurs after the holder gave his preapproval but on the same day that the holder gave his preapproval (e.g., occurs on Tuesday afternoon if the holder gave his preapproval on Tuesday morning); (b) has a transaction amount that is greater than a predetermined amount (e.g., $25); and (c) involves an predetermined channel (e.g., ATM).

In addition, in accordance with some embodiments, if the apparatus having the process flow 100 determines that the predetermined condition is met, the apparatus may: (a) authorize the transaction, as represented by block 150; (b) send the holder a message that includes information about the overage, information about an overage fee associated with the overage, the reason for authorizing the transaction (e.g., why/how the predetermined condition was met, etc.), and/or the like; (c) use an overage service to cover the overage and/or complete the transaction (e.g., provide funds and/or credit to the account to complete the transaction, etc.); (d) charge the account and/or the holder an overage fee for using the overage service to cover the overage and/or to complete the transaction; (e) charge the account and/or the holder an overage fee for incurring the overage; and/or the like. However, in some embodiments, if the apparatus determines that the predetermined condition is not met, the apparatus may: (a) decline the transaction; and/or (b) send the holder a message that includes information about the overage, the reason for declining the transaction (e.g., why/how the predetermined condition was not met, etc.), and/or the like.

Further regarding block 110, the holder can provide his preapproval and/or consent to the future overage in any way and/or using any apparatus. For example, in some embodiments, the holder provides his consent via an overage preapproval machine (e.g., the overage preapproval machine 320 described in connection with FIG. 3, etc.), a mobile device (e.g., mobile phone, portable gaming device, PDA, tablet computer, etc.), a transaction machine (e.g., ATM, POS device, etc.), a call center, an electronic banking account (e.g., online banking account, mobile banking account, text banking account, etc.), regular mail, email, text message, and/or the like.

Regarding block 120, the phrase “transaction machine,” as used herein, typically refers to an interactive computer terminal that is configured to initiate, perform, complete, and/or otherwise facilitate one or more transactions. Examples of transaction machines include, but are not limited to, POS devices (e.g., merchant terminals, etc.), automated teller machines (ATMs), self-service machines (e.g., vending machine, self-checkout machine, parking meter, etc.), public and/or business kiosks (e.g., an Internet kiosk, ticketing kiosk, bill pay kiosk, etc.), mobile phones (e.g., feature phone, smart phone, iPhone®, etc.), gaming devices (e.g., Nintendo WHO, PlayStation Portable®, etc.), computers (e.g., personal computers, tablet computers, laptop computers, etc.), personal digital assistants (PDAs), and/or the like. In some embodiments, the transaction machine is an overage preapproval machine (e.g., the overage preapproval machine 320, etc.), and/or vice versa. For example, in some embodiments, the holder uses an overage preapproval machine (e.g., mobile device, ATM, POS device, etc.) to consent to the future overage referred to in block 110, and that same overage preapproval machine is also the transaction machine referred to in block 120.

In some embodiments, the transaction machine referred to in block 120 is configured to send and/or receive communications (e.g., text messages, actionable alerts, phone calls, emails, social media-specific messages, etc.), present information via a user interface, navigate the Internet, play video games, and/or the like. For example, in some embodiments, the transaction machine is a smart phone (e.g., iPhone®, Motorola® Droid®, etc.) capable of initiating, performing, completing, and/or otherwise facilitating financial transactions. In some embodiments, the transaction machine is portable (e.g., not stationary) and/or can be carried and/or worn by and/or on a person. In some embodiments, the transaction machine includes one or more near field communication (NFC) interfaces that are configured to communicate with one or more NFC interfaces associated with a mobile device (e.g., mobile phone, PDA, portable gaming device, etc.). For example, in some embodiments, the NFC interface of a mobile phone can communicate account information and/or transaction information (e.g., account names, routing numbers, account numbers, usernames, passwords, PINS, transaction amounts, etc.) to and/or from the NFC interface of the transaction machine. In some of these embodiments, the mobile phone is configured to operate as a mobile wallet, meaning that the mobile phone can be used to make payments and/or otherwise engage in transactions at the transaction machine.

In some embodiments, the transaction machine referred to in block 120 is located in a public place and is available for public use (e.g., on a street corner, on the exterior wall of a banking center, at a public rest stop, etc.). In other embodiments, the transaction machine is additionally or alternatively located in a place of business and available for public and/or business customer use (e.g., in a retail store, post office, banking center, grocery store, etc.). In accordance with some embodiments, the transaction machine is not owned by the user of the transaction machine and/or the holder of the account referred to in block 110. However, in other embodiments, the transaction machine is located in a private place, is available for private use, and/or is owned by the user of the transaction machine and/or the holder referred to in block 120.

Further regarding block 120, the transaction involving the holder and the transaction machine can include any number and/or type of transaction(s) involving a transaction machine. For example, in some embodiments, the transaction includes one or more of the following: purchasing, renting, selling, and/or leasing goods and/or services (e.g., groceries, stamps, tickets, DVDs, vending machine items, etc.); withdrawing cash; making payments to creditors (e.g., paying monthly bills; paying federal, state, and/or local taxes and/or bills; etc.); sending remittances; transferring balances from one account to another account; loading money onto stored value cards; donating to charities; and/or the like. Like the transaction referred to in block 120, the future overage transaction referred to in block 110 can also include any number and/or type of transaction(s) involving a transaction machine (i.e., since the future overage transaction referred to in block 110 is the transaction referred to in block 120).

Also, the account referred to in the process flow 100 can include any number and/or type of account(s). For example, in some embodiments, the account includes a checking account, savings account, money market account, investment account, brokerage account, certificate of deposit account, and/or any other type of deposit account. In some embodiments, the deposit account is one or more accounts that can incur an overdraft and/or be overdrawn. Of course, it will be understood that embodiments of the present invention may also apply to one or more credit accounts, such as a credit card account, line of credit (LOC) account, store credit account, and/or the like. Additionally or alternatively, in some embodiments, the credit account is one or more accounts that can incur an amount “over limit.”

In some embodiments, the account, the transaction machine, and the apparatus having the process flow 100 are each controlled, serviced, owned, managed, operated, and/or maintained (collectively referred to herein as “maintained” for simplicity) by a single financial institution. For example, in some embodiments, the apparatus is maintained by a bank, the account is maintained by the bank, the transaction machine is owned by the bank, and the holder is a customer of the bank. Of course, it will be understood that, in some embodiments, the apparatus, the transaction machine, and/or the account are not maintained by the same financial institution (or any financial institution).

The transaction information referred to in block 120 can be any information that identifies, defines, describes, and/or is otherwise associated with the transaction. Exemplary transaction information includes, but is not limited to, the party(ies) involved in the transaction, the date and/or time of the transaction (e.g., when the transaction was initiated, etc.), the account(s) involved in the transaction, the transaction amount(s) associated with the transaction, the good(s) and/or service(s) involved in the transaction (e.g., product names, stock keeping unit (SKU) information, universal product code (UPC) information, etc.), a description of the transaction (which, itself, can include any transaction information, e.g., the description may describe the transaction status, the goods and/or services involved in the transaction, etc.), and/or the like.

The transaction information can also include any information that defines and/or identifies the type of the transaction. As understood herein, the transaction type of a transaction may be defined, at least in part, by the one or more goods and/or services involved in the transaction, the one or more types of accounts involved in the transaction (e.g., credit card transaction, savings account transaction, etc.), the one or more parties involved in the transaction (e.g., account holder, bank, teller, merchant, counterparty, etc.), when the transaction was initiated (e.g., time of day, day of week, etc.), and/or the like. In some embodiments, the transaction type is defined, at least in part, by the one or more channels through which the transaction is conducted, such as, for example, a POS device (e.g., merchant terminal, etc.), ATM, teller terminal, electronic banking account (e.g., online banking account, mobile banking account, SMS banking account, etc.), personal computer, kiosk, call center, and/or the like. Additionally or alternatively, in some embodiments, the transaction type is defined, at least in part, by the one or more instruments and/or methods used to conduct the transaction, such as, for example, paper checks, electronic checks, debit cards, credit cards, ATM cards, checkcards, wire transfers, online bill pay, automated clearing house (ACH), contactless payments, near field communication (NFC) interface payments, cash payments, and/or the like.

In some embodiments, the transaction information additionally or alternatively identifies and/or describes one or more merchant category codes (MCCs) associated with the transaction. As used herein, the phrase “merchant category code” generally refers to a number assigned to a merchant by a financial institution, where the number is used to classify the merchant by the type of goods and/or services the merchant provides. In some embodiments, the merchant category code is a four digit number assigned by VISA®, MasterCard®, and/or some other credit card provider (which, in some embodiments, is a bank). Exemplary merchant category codes include “5814” for fast food restaurants, “5933” for pawn shops, “8062” for hospitals, “5411” for grocery supermarkets, and “3501” for Holiday Inn Express®. A merchant category code may generally refer to the goods and/or services provided by a merchant (e.g., hospital, fast food restaurant, etc.) and/or may specifically identify the name of an individual merchant (e.g., Holiday Inn Express®, Mirage Hotel & Casino®, etc.). In other words, individual industries and/or individual merchants can have their own merchant category codes. In some embodiments, a transaction type may be defined, at least in part, by one or more merchant category codes associated with the transaction.

It will be understood that any given transaction may have more than one transaction type. For example, in accordance with some embodiments, a cash withdrawal transaction conducted an ATM may be defined as a cash-related transaction, a withdrawal transaction, and/or an ATM transaction. As another example, in accordance with some embodiments, a purchase transaction involving a POS device and a mobile device, where each of the POS device and the mobile device has an NFC interface, may be defined as a purchase transaction, a POS device transaction, mobile device transaction, an NFC interface transaction, and/or a contactless payment transaction. As still another example, in accordance with some embodiments, a purchase transaction involving a POS device maintained by a grocery store may be defined as a purchase transaction, a POS device transaction, a grocery store transaction, and/or a merchant category code “5411” transaction.

Also regarding block 120, the apparatus having the process flow 100 can be configured to receive the transaction information in any way. For example, in some embodiments, the apparatus is configured to receive an authorization request associated with the transaction, where the authorization request includes the transaction information. In some embodiments, the apparatus is embodied as an authorization apparatus maintained by a financial institution, where the apparatus is configured to consider, approve, and/or decline authorization requests for debit transactions, credit transactions, ATM transactions, POS device transactions, and/or one or more other types of transactions that involve one or more accounts maintained by the financial institution.

In some embodiments, the apparatus having the process flow 100 is configured to receive the transaction information based at least partially on the holder presenting account information (e.g., account number, debit card number, credit card number, credentials, PIN, expiration date of debit card or credit card, card verification value (CVV), name(s) of holder(s) of the account, etc.) at the transaction machine. For example, in some embodiments, the holder presents account information at the transaction machine by swiping a debit card or credit card through the POS device. As another example, in some embodiments, the holder presents account information at the transaction machine by inputting account information into the transaction machine via a user interface associated with the transaction machine. As still another example, in some embodiments, the holder presents account information at the transaction machine by “tapping” an NFC-enabled mobile device at an NFC-enabled transaction machine (e.g., holding the NFC interface of the mobile device within approximately four inches of the NFC interface of the transaction machine, etc.) in order to communicate the account information from the mobile device to the transaction machine.

Additionally or alternatively, the apparatus having the process flow 100 can be configured to receive the transaction information directly or indirectly from the source of the transaction. For example, in some embodiments, the apparatus is located remotely from the transaction machine but is operatively connected to the transaction machine via a payment network, telephone network, and/or some other telecommunications network. As another example, the apparatus may include, be included in, and/or be embodied as a transaction machine. For example, in some embodiments, the apparatus having the process flow 100 includes the transaction machine referred to in block 110. As still another example, in some embodiments, the apparatus having the process flow 100 is embodied as a transaction machine separate from, and/or different than, the transaction machine mentioned in the process flow 100.

Regarding block 130, the term “overage,” as used herein, generally refers to the difference between: (a) the total amount of one or more purchases, draws, fees, charges, balance transfers, debt obligations, and/or other liabilities incurred, or that will be incurred, by an account as a result of a transaction, and (b) the amount of funds and/or credit available to the account immediately prior to the transaction. In some embodiments, the overage is referred to as an “overdraft” if the account that incurs the overage, or will incur the overage, is a deposit account. For example, if a checking account has an available balance of $25 immediately before the checking account is used to pay a $50 electric bill, then the checking account will incur a $25 overdraft as a result of paying the bill. In some embodiments, the term “overdraft” refers to the amount by which the balance of an account is negative. For example, if a deposit account has an available balance of −$65, then the deposit account has one or more overdrafts totaling $65. Additionally or alternatively, in some embodiments, the term “overdraft” refers to a situation where a deposit account is found to have insufficient funds (NSF) to cover a transaction.

In some embodiments, the overage is referred to as “going over limit” and/or “incurring an over limit amount” if the account that incurs the overage or will incur the overage is a credit account. For example, if a credit account has $500 in available credit immediately prior to the credit account being used to make a $600 purchase, then it will be understood that the credit account will go over its credit limit by $100 as a result of the purchase. Additionally or alternatively, in some embodiments, the phrase “over limit amount” generally refers to the difference between an account balance for the credit account and a credit limit (sometimes referred to as “credit line”) associated with the credit account. For example, if a credit account has a $5,000 credit limit and a $5,300 account balance, then it will be understood that the credit account has incurred one or more over limit amounts totaling $300.

Further regarding block 130, the apparatus configured to perform the process flow 100 can be configured to determine that the account will incur an overage as a result of a present, initiated, and/or pending transaction. For example, in some embodiments, the apparatus is configured to make the overage determination based at least partially on determining that the transaction has been initiated (e.g., at a POS device), but has not yet been completed. In addition, the apparatus can be configured to make the overage determination in any way. For example, in some embodiments, the apparatus is configured to make the overage determination by determining that the account does not have sufficient available funds and/or credit to cover the transaction. In some embodiments, the apparatus having the process flow 100 includes and/or is embodied as a financial transaction processing apparatus that is configured to process financial transactions involving the account and/or the transaction machine referred to in block 120. In some of these embodiments, the apparatus is configured to make overage determinations and/or condition determinations for the account at the same time as, and/or nearly the same time as, the apparatus is processing transactions involving the account.

In some embodiments, the apparatus includes and/or is embodied as an authorization apparatus (e.g., the authorization apparatus 330 referred to in FIG. 3, etc.) that is configured to consider, authorize, and/or decline authorization requests and/or financial transactions. The apparatus configured to perform the process flow 100 can be configured to make overage determinations and/or condition determinations in real time and/or in substantially real time. In some embodiments, the apparatus is configured to determine the overage immediately or nearly immediately after the overage transaction has been initiated at the transaction machine (e.g., upon the swipe of a debit or credit card through a POS device, upon the holder selecting an amount to withdraw from an ATM, etc.). However, the apparatus having the process flow 100 can be configured to make the overage determination and/or the condition determination at any time from when the holder approaches the transaction machine to when the holder leaves the transaction machine. Additionally or alternatively, the apparatus can be configured to make the overage determination and/or condition determination at any time from when the holder initiates and/or engages in the transaction at the transaction machine to when the transaction is completed.

Regarding block 140, the apparatus can be configured to make the condition determination in any way. For example, in some embodiments, the apparatus is configured to store the one or more terms of the predetermined condition and/or other information associated with the predetermined condition (collectively, the “condition information”) in a datastore, and the apparatus is configured to make the condition determination based at least partially on accessing the datastore and/or comparing the condition information to the transaction information referred to in block 120. Of course, depending on the one or more terms of the predetermined condition, the apparatus may compare the condition information to something other than the transaction information referred to in block 120. For example, if the predetermined condition relates to the number of overdraft transactions involving the account, the apparatus may be configured to compare the condition information to, for example, the transaction history associated with the account (e.g., to determine the number of overdraft transactions in which the account has engaged over a particular period of time, etc.). As another example, if the predetermined condition relates to the amount by which the account is overdrawn or over limit, the apparatus may be configured to compare the condition information to, for example, the available balance and/or credit associated with the account (e.g., as a result of the overage transaction, immediately before the overage transaction, etc.). As still another example, if the predetermined condition relates to a merchant and/or channel involved in the transaction, the apparatus may be configured to compare the condition information to, for example, one or more rules for determining merchant types and/or channel types, where those one or more rules are stored in one or more databases and/or other bank systems.

Regarding block 150, the apparatus can be configured to authorize the transaction in any way. For example, in some embodiments, the apparatus is configured to send, to the transaction machine referred to in the process flow 100, one or more instructions to complete (and/or for completing) the transaction. In some embodiments, the apparatus is configured to authorize the transaction by approving an authorization request associated with the transaction. In some embodiments, the authorization request approved by the apparatus having the process flow 100 was included in the transaction information referred to in block 120. In some embodiments where the transaction machine referred to in blocks 120 is the apparatus having the process flow 100, the transaction machine authorizes and/or completes the transaction based at least partially on making the overage determination, making the condition determination, and/or determining that the consent is valid (e.g., covers) the transaction. In some embodiments, the transaction machine completes the transaction by performing one or more meaningful actions relevant to the transaction, such as, for example, dispensing cash, accepting a purchase transaction, accepting a check deposit, printing a receipt and/or statement, loading a prepaid card, transferring funds, and/or the like. In some embodiments, these one or more actions constitute the exchange central to the transaction, define the transaction, are desired by the holder to be performed, and/or were the reason the holder arrived at the transaction machine in the first place.

In accordance with some embodiments, the apparatus configured to perform the process flow 100 is configured to perform the portions of the process flow 100 represented by blocks 120-150 at some point after the holder approaches the transaction machine for the transaction and before the holder leaves the transaction machine. In some embodiments, this means that the apparatus is configured to perform the one or more portions of the process flow 100 (e.g., receive the transaction information, make the overage determination, make the condition determination, authorize the transaction, etc.) during the transaction involving the transaction machine and the holder and/or while the holder is still at the transaction machine.

The apparatus configured to perform the process flow 100 can be configured to perform any of the portions of the process flow 100 represented by blocks 110-150 upon or after one or more triggering events (which, in some embodiments, is one or more of the other portions of the process flow 100). As used herein, a “triggering event” refers to an event that automatically (i.e., without human intervention) triggers the execution, performance, and/or implementation of a triggered action, either immediately, nearly immediately, or sometime after (e.g., within minutes, etc.) the occurrence of the triggering event. For example, in some embodiments, the apparatus configured to perform the process flow 100 is configured such that the apparatus making the overage determination (the triggering event) automatically and immediately or nearly immediately (e.g., within 1-30 seconds, etc.) triggers the apparatus to determine whether (and/or that) the predetermined condition is met and/or whether (and/or that) the consent is valid for the transaction (the triggered action(s)). In some embodiments, the apparatus is additionally or alternatively configured to authorize and/or complete the transaction (triggered action) automatically and immediately or nearly immediately after determining that the predetermined condition is met and/or that the consent is valid (triggering event).

In accordance with some embodiments, the apparatus configured to perform the process flow 100 is configured to automatically perform one or more of the portions of the process flow 100 represented by blocks 110-150, whereas in other embodiments, one or more of the portions of the process flow 100 represented by blocks 110-150 require and/or involve human intervention (e.g., a user operating the apparatus configured to perform the process flow 100, etc.). In addition, it will be understood that, in some embodiments, the apparatus configured to perform the process flow 100 (and/or a user thereof) is configured to perform one or more portions (or combinations of portions) of the process flow 100, from start to finish, within moments, seconds, and/or minutes (e.g., within approximately 1-15 minutes from start to finish, etc.). As an example, in some embodiments, the apparatus having the process flow 100 is configured to authorize and/or complete the transaction within moments, seconds, and/or minutes (e.g., within approximately 1-15 minutes, etc.) of: (a) receiving the transaction information associated with the transaction; and/or (b) determining that the account will incur an overage as a result of the transaction.

As mentioned above, in some embodiments, the apparatus having the process flow 100 is configured to provide, implement, and/or is otherwise associated with an overage service. For example, in some embodiments, the apparatus is configured to prompt, via a user interface associated with an overage preapproval machine, the holder to consent to, accept, preapprove, and/or agree to (collectively referred to herein as “agree to” for simplicity) one or more terms of the overage service. In some embodiments, the apparatus prompts the holder to agree to the one or more terms of the overage service by prompting the holder to “opt into” and/or otherwise enroll in the overage service. In some embodiments, as required by one or more laws, rules, and/or regulations, the holder must opt into the overage service before the holder can participate in and/or otherwise use the overage service. It will be understood that the holder may enroll in the overage service at a banking center, through an electronic banking account, via a call center, and/or in some other way.

Additionally or alternatively, in some embodiments, the apparatus is configured to receive the holder's consent to the future overage (and/or to an associated overage fee), as represented by block 110, by receiving the holder's agreement to the one or more terms of the overage service. Still further, in some embodiments, the apparatus is configured to send a confirmation message to the holder, where the confirmation message includes information that confirms the holder's agreement to the one or more terms of the overage service (and/or the holder's agreement to opt into and/or otherwise enroll in the overage service, and/or the holder's agreement to use the overage service for the future overage transaction). In other embodiments, the apparatus is configured to send this confirmation message to the holder's mobile device, to an electronic banking account (e.g., online banking account, mobile banking account, etc.) associated with the account, and/or to the overage preapproval machine that the holder used to indicate his consent to the future overage.

As used herein, the phrase “overage service” generally refers to a service that provides an account holder, account, and/or counterparty with the funds and/or credit necessary to complete an overage transaction. For example, in some embodiments, where a transaction, if completed, would overdraft a checking account by $10, the overage service can provide the checking account with the $10 needed to complete the transaction. In accordance with some embodiments, the overage service is referred to as an overdraft service if the account participating in the service is a deposit account. In other embodiments, the overage service is referred to as an over limit service if the account participating in the service is a credit account.

It will be understood that the overage service includes one or more terms, which define the one or more rights, responsibilities, privileges, fees, features, and/or obligations of the overage service. For example, in some embodiments, the one or more terms of the overage service describe how the overage service works; identify the overage service provider; define what constitutes an overage; identify the one or more overage fees charged for enrolling in the overage service, for participating in the overage service, and/or for engaging in an overage transaction; and/or the like.

In some embodiments, the overage service is provided by a financial institution, such as a bank, and is funded by that financial institution (and not by an account held by and/or otherwise associated with the holder). For example, in some embodiments, the overage service is provided by the same financial institution that maintains the transaction machine, the apparatus configured to perform the process flow 100, and/or the account that incurs, or will incur, the overage. It will be understood that, in some embodiments, the overage service (and/or the overage service provider) is regulated in the United States by the Electronic Funds Transfer Act, also known as Federal Reserve Board Regulation E (hereinafter “Regulation E”). In other embodiments, the overage service (and/or overage service provider) is regulated in the United States by the Credit Card Accountability Responsibility and Disclosure Act of 2009, which is codified in the United States as Public Law No. 111-24 (sometimes referred to herein, for simplicity, as the “Credit CARD Act of 2009” or the “CARD Act”). In some embodiments, the overage service does not contractually obligate the overage service provider to cover overages. In other words, in such embodiments, the overage service provider may choose to cover overdraft and/or over limit transactions at its discretion. However, in other embodiments, the overage service provider is contractually obligated and/or otherwise required to cover overages incurred by an account.

In some embodiments, one or more portions of the process flow 100 may be configured to comply with one or more portions of a law, rule, and/or regulation that is directed to and/or otherwise relates to an overage (collectively referred to herein as “overage regulation” for simplicity). For example, in the United States, Regulation E regulates overdraft services provided by financial institutions. Accordingly, it will be understood that some embodiments of the present invention enable a financial institution to comply with Regulation E, the CARD Act, and/or one or more other overage regulations. For example, in some embodiments, receiving the holder's consent to the future overage (and/or agreement to one or more terms of an overage service), as represented by block 110, may comply with one or more consent, opt-in, and/or revocation requirements of an overage regulation. As another example, in some embodiments, sending the holder a confirmation message that indicates the holder's consent to the future overage (and/or the one or more terms of the overage service) may comply with one or more confirmation requirements of an overage regulation.

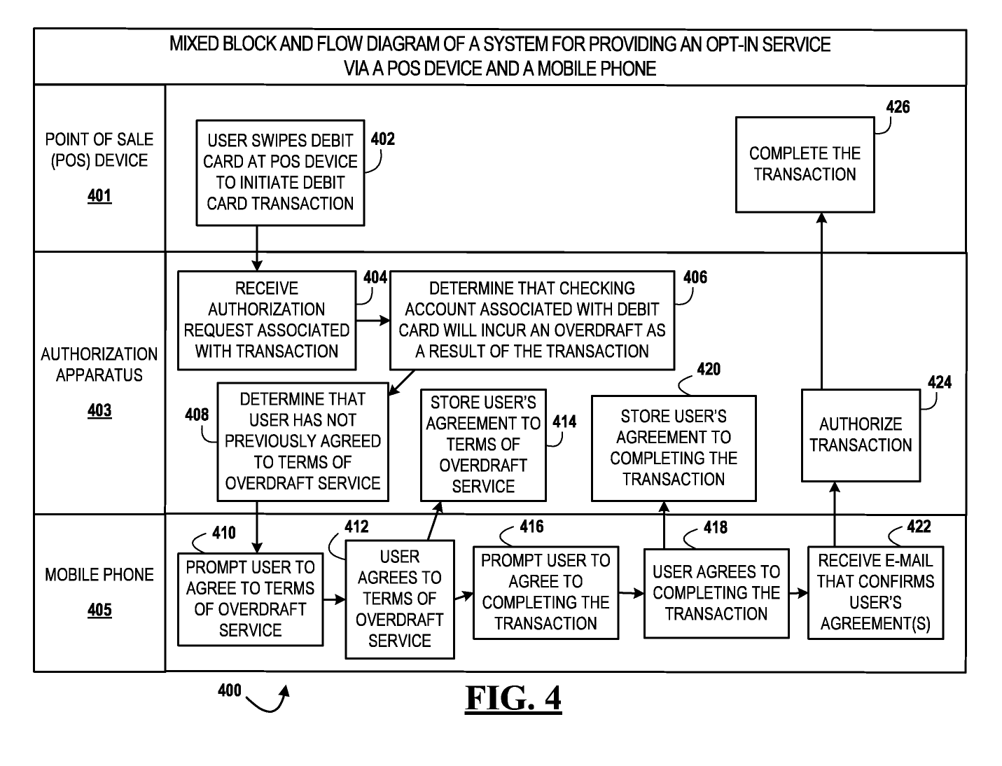

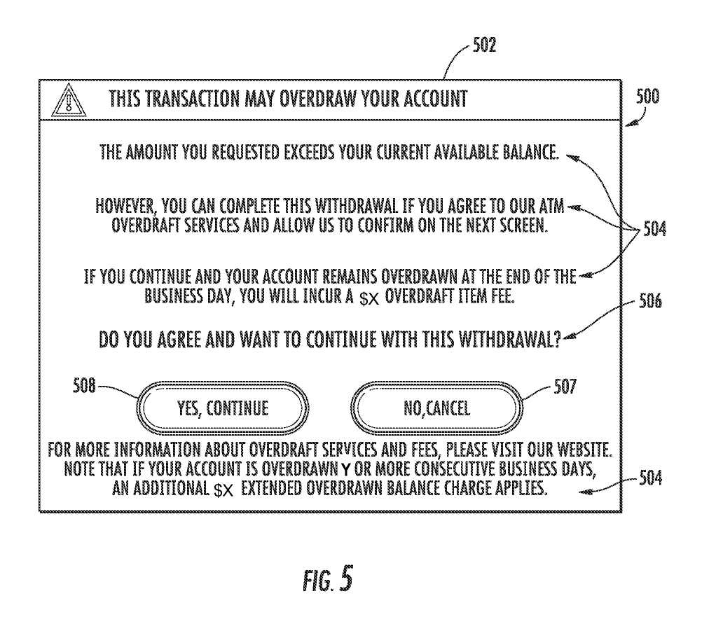

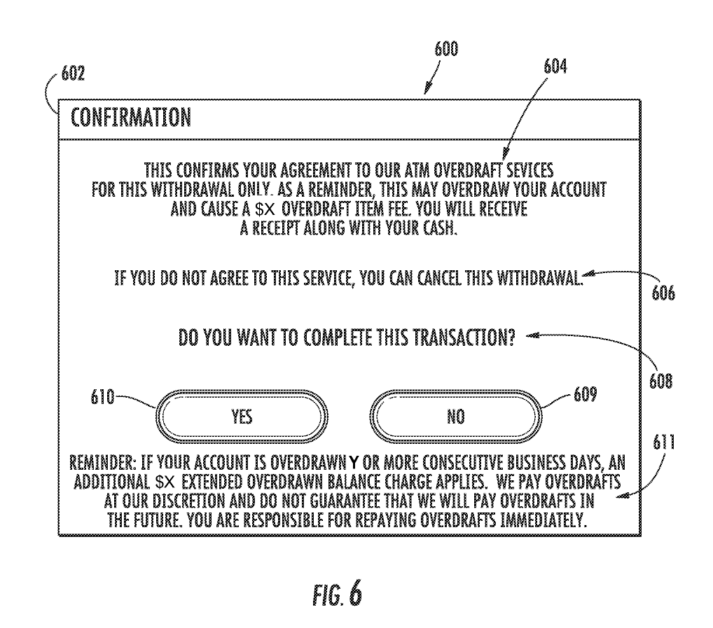

It will be understood that the apparatus having the process flow 100 can be configured to perform one or more portions of any embodiment described and/or contemplated herein, such as, for example, one or more portions of the process flow 200 described herein and/or one or more portions of the process flows described in connection with FIGS. 4 and/or 5. Also, the number, order, and/or content of the portions of the process flow 100 are exemplary and may vary. For example, in some embodiments, the apparatus having the process flow 100 is configured to assess a fee associated with the overage (e.g., charge an overage fee to the account and/or to the holder, etc.), where the fee is based at least partially on the account incurring an overage, where the fee is based at least partially on the amount of the overage, and/or where the fee is assessed after authorizing and/or completing the transaction. In some embodiments, the apparatus is configured to: (a) assess the account an overage fee based at least partially on the apparatus determining that the account settled negative at the end of the day in which the transaction occurred; and/or (b) determine not to assess the account an overage fee based at least partially on the apparatus determining that the account settled non-negative (e.g., the account has a zero or positive available balance, etc.) at the end of the day in which the transaction occurred.

As another example, in some embodiments, the apparatus is configured to determine whether the holder has preapproved and/or otherwise consented to the overage referred to in block 130 and/or agreed to one or more terms of an overage service. As another example, in some embodiments, the apparatus is configured to determine whether the consent covers the transaction based at least partially on determining whether the predetermined condition is met. As still another example, in some embodiments, the apparatus is configured to authorize the transaction based at least partially on determining whether the holder consented to the overage and/or based at least partially on determining whether the consent is valid for the transaction. As still another example, in some embodiments, the apparatus is configured to send a confirmation message to the holder that confirms the holder's consent to the future overage and/or that indicates the one or more terms of the predetermined condition. As still another example, in some embodiments, the apparatus is configured to store (e.g., in a datastore, in an account profile associated with the account, in an online banking account, etc.) the holder's preapproval and/or consent to the future overage and/or information associated with the predetermined condition (e.g., the one or more terms of the predetermined condition), which may, in some embodiments, be required by one or more government and/or financial institution regulations (and/or one or more overage regulations).

As a further example, in some embodiments, the apparatus (and/or the transaction machine referred to in block 120) is configured to authenticate (e.g., confirm the identity of) the holder as a condition of authorizing the transaction. In some embodiments, the apparatus (and/or transaction machine) is configured to authenticate the holder based at least partially on account information (e.g., ATM/debit/credit card, account number, username, password, PIN, biometric information, barcode, etc.) the holder inserts, provides, and/or presents (collectively referred to herein as “presents” for simplicity) to the transaction machine and/or to the apparatus having the process flow 100. As another example, in some embodiments, the apparatus is configured to post transaction information associated with the transaction (e.g., the transaction information referred to in block 110, etc.) to an electronic banking account associated with the account.

As a further example, in some embodiments, the apparatus having the process flow 100 is configured to generate and/or send disclosure information to the holder (i.e., in addition to any disclosure information referred to in the process flow 100) before the apparatus receives the holder's consent to the future overage, before the overage transaction is initiated, before the holder approaches the transaction machine, and/or before the apparatus receives the transaction information. For example, in some embodiments, before the apparatus receives the holder's consent to the future overage, the apparatus is configured to generate and/or send disclosure information to the holder that defines one or more terms of an overage service, one or more predetermined conditions (and/or one or more terms thereof), etc. This disclosure information can be sent via one or more emails, telephone calls, text messages, instant messages, IVR communications, communications specific to one or more social media networks and/or applications, direct mailings, electronic banking account-specific messages, and/or the like. In some embodiments, the disclosure information is included in one or more communications typically sent to a holder, such as, for example, a periodic (e.g., monthly) account statement.

In some embodiments, sending the disclosure information to the holder may help a financial institution comply with one or more requirements of an overage regulation. For example, in some embodiments, the disclosure information includes information similar or identical to the information shown in the A-9 Model Consent Form for Overdraft Services, which is provided by the Federal Reserve at http://www.federalreserve.gov/DCCA/RegulationE/20081218/A-9.pdf and is incorporated herein by reference in its entirety. As such, the holder consenting to the future overage, as represented by block 110, can include the holder agreeing, electronically signing, and/or otherwise acknowledging that: (a) the holder has received the disclosure information; (b) the holder understands the one or more terms of the overage service defined in the disclosure information; (c) the holder agrees to the one or more terms of the overage service defined in the disclosure information (e.g., the holder enrolls in the overage service, etc.); (d) the holder agrees to the one or more predetermined conditions (and/or the one or more terms thereof) defined in the disclosure information; (e) the holder is already enrolled in the overage service; and/or (f) the holder agrees to use the overage service to complete the future overage transaction (e.g., subject to the predetermined condition). Similarly, the receiving the holder's consent to the future overage, as represented by block 110, can include receiving one or more of the holder's agreements, signatures, and/or other acknowledgements in response to the apparatus prompting the holder to indicate, make, give, and/or send those agreements, signatures, and/or other acknowledgements. In some embodiments, because the holder is sent the disclosure information, the receiving the holder's consent to the future overage may, individually or collectively, comply with one or more requirements of Regulation E and/or of one or more other overage regulations.

Furthermore, in some embodiments of the invention, the apparatus having the process flow 100 includes a memory device that has information stored therein about whether the holder has been mailed or otherwise sent overage service disclosure information prior to the transaction referred to in block 110. In some embodiments, the memory device additionally or alternatively stores information about whether the holder has enrolled in an overage service prior to the transaction referred to in block 110. In some such embodiments of the invention, the apparatus may condition authorizing the overage transaction based at least partially whether there is an indication in the memory device that the holder has already received the disclosure information and/or is already enrolled in the overage service.

Referring now to FIG. 2, a more-detailed process flow 200 for providing an overage service subject to a customer-selected, predetermined condition is provided, in accordance with an embodiment of the present invention. It will be understood that the process flow 200 illustrated in FIG. 2 represents an example embodiment of the process flow 100 described in connection with FIG. 1. In accordance with some embodiments, one or more portions of the process flow 200 are performed by an apparatus (i.e., one or more apparatuses) having hardware and/or software configured to perform one or more portions of the process flow 200. The apparatus having the process flow 200 includes, is included in, is embodied as, and/or can be operatively connected to the transaction machine referred to in the process flow 200. In accordance with some embodiments, the apparatus having the process flow 200 is maintained by a bank for the benefit of its customers. Also in accordance with some embodiments, the customer referred to in the process flow 200 is the user of the transaction machine and a customer of the bank. In addition, the account (e.g., checking account, credit card account, etc.) referred to in the process flow 200 is an account held by the customer and maintained by the bank.

As represented by block 205, the bank customer enrolls in an overage service provided by the bank (e.g., via an online banking account, mobile phone, banking center, call center, overage preapproval machine 320, etc.). As represented by block 210, the customer also provides his consent to one or more future overages, where the consent is valid only if a predetermined condition is met. For example, in some embodiments, the predetermined condition is such that the consent is valid only if the amount of the overage exceeds a predetermined amount. As with enrolling in the overage service, the customer may provide his consent in any way, such as, for example, via an online banking account associated with the account and/or by using an overage preapproval machine. After the customer's consent is provided, the apparatus having the process flow 200 is configured to store the customer's consent in a datastore (e.g., in an account profile associated with the account, which is stored in a computer readable medium, etc.), as represented by block 215. In some embodiments, storing the customer's consent also includes storing information associated with the predetermined condition (e.g., the one or more terms of the predetermined condition, etc.). It will be understood that, in some embodiments, the customer consents to the future overage when the customer enrolls in the overage service, but in other embodiments, the customer first enrolls in the overage service and then later consents to the future overage. In addition, in this example embodiment, the customer provides and/or selects the predetermined condition, but, in other embodiments, the predetermined condition can be selected for, and/or provided to, the customer. The predetermined condition (and/or one or more terms thereof) can be selected after the customer enrolls in the overage service.

After providing his consent to the future overage, the bank customer approaches the transaction machine for the purpose of engaging in a transaction using the transaction machine, as represented by block 220. After arriving at the transaction machine, the customer presents account information at the transaction machine, as represented by block 225. For example, in some embodiments where the transaction machine is a POS device, the customer may swipe a debit and/or credit card associated with the account through the POS device in order to communicate account information associated with the account to the POS device and/or to the apparatus having the process flow 200. As another example, in some embodiments where the transaction machine is a personal computer, the customer may input account information into a web page associated with the transaction that is displayed at the personal computer. After the account information is presented, the transaction machine (and/or the apparatus having the process flow 200) identifies and/or authenticates the customer, as represented by block 230. In some embodiments, the transaction machine authenticates the customer based at least partially on the account information (e.g., userid/password, PIN, checkcard, account number, etc.) the customer presents to the transaction machine.

After being authenticated, the customer selects the transaction and/or agrees to the transaction amount, as represented by block 235. Then, as represented by block 240, the transaction machine sends an authorization request to the apparatus having the process flow 200, where the authorization request identifies and/or describes the transaction, the customer, the account, and/or the like. Upon receiving the authorization request, the apparatus must determine whether the account has sufficient available funds and/or credit to cover the transaction, as represented by block 245. If so, then the apparatus, as represented by blocks 250 and 255, approves the authorization request and/or instructs the transaction machine to complete the transaction. After the transaction is completed at the transaction machine, the customer leaves the transaction machine, as represented by block 260.

However, if the apparatus having the process flow 200 determines that the account does not have sufficient available funds and/or credit to cover the transaction, then the apparatus is configured to determine whether the customer is enrolled in an overage service provided by the financial institution, as represented by block 265. If the customer is not enrolled in the overage service, then the apparatus having the process flow 200 (and/or the transaction machine) is configured decline the authorization request and/or otherwise decline, cancel, abort, and/or reject the transaction, as represented by block 270. Thus, in this example embodiment, the overage service cannot be used to complete the transaction if the holder is not already enrolled in the overage service prior to the transaction being initiated. However, other embodiments may be different. For example, in some embodiments, the apparatus is configured to enroll the customer in the overage service at some point during the transaction, such as, for example, after determining that the customer is not enrolled in the overage service and/or before the customer leaves the transaction machine.

Returning to FIG. 2, if the apparatus having the process flow 200 determines that the customer is enrolled in the overage service, then the apparatus is configured to determine whether the predetermined condition is met, as represented by block 275. In accordance with some embodiments, this condition determination is made after the apparatus determines that the customer is enrolled in the overage service. In some embodiments, the apparatus is configured to make the condition determination based at least partially on accessing the datastore (e.g., accessing the account profile associated with the customer's account, etc.) referred to in block 215, determining the one or more terms of the predetermined condition, and then comparing the one or more terms of the predetermined condition to transaction information associated with the transaction (e.g., the transaction amount referred to in block 235, the amount of the overage, the transaction machine referred to in block 230, etc.). Additionally or alternatively, in some embodiments, the apparatus having the process flow 200 is configured to make the condition determination based at least partially on comparing the one or more terms of the predetermined condition to the transaction history associated with the account (e.g., the number of the overages incurred by the account since the holder's consent was provided, etc.). If the predetermined condition is met, then the apparatus having the process flow 200 is configured to approve the authorization request, as represented by block 250. However, if the predetermined condition is not met, then the apparatus is configured to decline the authorization request, as represented by block 270. It will be understood that, in some embodiments, the customer does not know, during the transaction and/or while the customer is at the transaction machine, that the apparatus has determined whether the customer is enrolled in the overage service, whether the predetermined condition is met, and/or even whether the transaction is an overage transaction. However, in other embodiments, the apparatus having the process flow 200 is configured to send a message (e.g., an overage alert, an overage service use notification, etc.) to the customer (e.g., via a mobile phone carried by the customer, via the transaction machine being used to conduct the transaction, etc.) before and/or after the customer leaves the transaction machine.

Also, in some embodiments, one or more portions of the process flow 200 may comply with one or more requirements of an overage regulation (e.g., Regulation E and/or the CARD Act in the United States, etc.). For example, in some embodiments, receiving the customer's consent to the future overage, as represented by block 210, may comply with one or more consent requirements of an overage regulation. In addition, in some embodiments, approving the authorization request, as represented by block 250, may comply with one or more overage regulations because, for example, the customer gave his consent to the overage before the transaction that resulted in the overage was initiated and/or because the customer was authenticated by the transaction machine and/or by the apparatus having the process flow 200 before the authorization request was approved.

Of course, it will also be understood that the embodiment illustrated in FIG. 2 is merely exemplary and that other embodiments may vary without departing from the scope and spirit of the present invention. For example, in some embodiments, the apparatus having the process flow 200 is configured to provide funds and/or credit sufficient to complete the transaction. In such embodiments, the apparatus may provide the funds and/or credit to the account, the customer, and/or to the counterparty involved in the transaction (e.g., a merchant, etc.). Additionally or alternatively, in some embodiments, the apparatus may provide only the minimum amount of funds and/or credit needed to complete the transaction. In addition, the apparatus having the process flow 200 can be configured to perform one or more portions of the process flow 200 in real time, in substantially real time, and/or at one or more predetermined times. The apparatus having the process flow 200 may be configured to perform any of the portions of the process flow 200 represented by blocks 205-275 upon or after one or more triggering events (which, in some embodiments, is the performance of one or more of the other portions of the process flow 200). In addition, in some embodiments, the apparatus having the process flow 200 (and/or a customer thereof) is configured to perform each portion of the process flow 200, from start to finish, within moments, seconds, and/or minutes (e.g., within approximately 1-15 minutes, etc.).

Referring now to FIG. 3, a system 300 is illustrated for providing an overage service subject to one or more predetermined conditions, in accordance with an embodiment of the present invention. As illustrated, the system 300 includes a network 310, an overage preapproval machine 320, and an authorization apparatus 330. The system 300 also includes a personal computer 301, a banking center 302, a POS device 303, an ATM 304, a mobile phone 305, and a call center 306, which are sometimes collectively referred to herein as “the channels 301-306” for simplicity. FIG. 3 also shows an account holder 308 and an account 307. The account 307 (e.g., credit account, deposit account, etc.) is associated with an electronic banking account 309 (e.g., online banking account, mobile banking account, text banking account, etc.). As shown, the holder 308 has access to the overage preapproval machine 320 and the channels 301-306. In accordance with some embodiments, the overage preapproval machine 320, the authorization apparatus 330, and one or more of the channels 301-306 are each maintained by the same financial institution. For example, in some embodiments, the holder 308 is a customer of the financial institution, the authorization apparatus 330 is embodied as an ATM transaction server maintained by the financial institution, the ATM 304 is maintained by the financial institution, and the overage preapproval machine 320 is embodied as a banking center kiosk maintained by the financial institution. However, in other embodiments, the overage preapproval machine 320 and the authorization apparatus 330 are maintained by separate entities. For example, in some embodiments, the authorization apparatus 330 is maintained by a bank, and the overage preapproval machine 320 is associated with the holder 308 and/or is carried, owned, possessed, and/or owned by the holder 308.

As shown in FIG. 3, the overage preapproval machine 320, the authorization apparatus 330, and the channels 301-306 are each operatively and selectively connected to the network 310, which may include one or more separate networks. The network 310 may include one or more payment networks (e.g., interbank networks, Visa's® payment network VisaNet®, MasterCard's® payment network BankNet®, any wireline and/or wireless network over which payment information is sent, etc.), telephone networks (e.g., cellular networks, CDMA networks, any wireline and/or wireless network over which communications to telephones and/or mobile phones are sent, etc.), local area networks (LANs), wide area networks (WANs), global area networks (GANs) (e.g., the Internet, etc.), and/or one or more other telecommunications networks. For example, in some embodiments, the network 310 includes a telephone network (e.g., for communicating with the overage preapproval machine 320, the mobile phone 305, etc.) and a payment network (e.g., for communicating with the overage preapproval machine 320, the POS device 303, the ATM 304, etc.). It will also be understood that the network 310 may be secure and/or unsecure and may also include wireless and/or wireline technology.

The overage preapproval machine 320 may include any computerized apparatus that can be configured to perform any one or more of the functions of the overage preapproval machine 320 described and/or contemplated herein. It will also be understood that the overage preapproval machine 320 can include and/or be embodied as, any transaction machine described and/or contemplated herein, such as, for example, a personal computer, ATM, POS device, gaming device, mobile device (e.g., mobile phone, tablet computer, PDA, portable gaming device, etc.), banking center kiosk, module, front end system, back end system, network device, etc. Thus, it will be understood that, in some embodiments, the overage preapproval machine 320 is the same type of machine as the personal computer 301, the POS device 303, the ATM 304, and/or the mobile phone 305. (In some of these embodiments, the overage preapproval machine 320 is the personal computer 301, the POS device 303, the ATM 604, and/or the mobile phone 305.) In some embodiments, the overage preapproval machine 320 is configured to initiate, perform, complete, and/or otherwise facilitate one or more financial and/or non-financial transactions, including, for example, purchasing, renting, selling, and/or leasing goods and/or services (e.g., groceries, stamps, tickets, gift certificates, DVDs, etc.); withdrawing cash; making deposits (e.g., cash, checks, etc.); making payments (e.g., paying telephone bills, sending remittances, etc.); accessing the Internet; enrolling in overage services; communicating preapproval and/or consent to one or more future overages; selecting predetermined conditions associated with that preapproval and/or consent; and/or the like.

As illustrated in FIG. 3, in accordance with some embodiments of the present invention, the overage preapproval machine 320 includes a communication interface 322, a processor 324, a memory 326 having a preapproval application 327 stored therein, and a user interface 329. In such embodiments, the processor 324 is operatively and selectively connected to the communication interface 322, the user interface 329, and the memory 326.

Each communication interface described herein, including the communication interface 322, generally includes hardware, and, in some instances, software, that enables a portion of the system 300, such as the overage preapproval machine 320, to send, receive, and/or otherwise communicate information to and/or from the communication interface of one or more other portions of the system 300. For example, the communication interface 322 of the overage preapproval machine 320 may include a modem, network interface controller (NIC), near field communication (NFC) interface, network adapter, network interface card, and/or some other electronic communication device that operatively connects the overage preapproval machine 320 to another portion of the system 300, such as, for example, the authorization apparatus 330.

Each processor described herein, including the processor 324, generally includes circuitry for implementing the audio, visual, and/or logic functions of that portion of the system 300. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the preapproval application 327 of the memory 326 of the overage preapproval machine 320.

Each memory device described herein, including the memory 326 for storing the preapproval application 327 and other information, may include any computer-readable medium. For example, the memory may include volatile memory, such as volatile random access memory (RAM) having a cache area for the temporary storage of data. Memory may also include non-volatile memory, which may be embedded and/or may be removable. The non-volatile memory may additionally or alternatively include an EEPROM, flash memory, and/or the like. The memory may store any one or more of portions of information used by the apparatus in which it resides to implement the functions of that apparatus.

As shown in FIG. 3, the memory 326 includes the preapproval application 327. It will be understood that the preapproval application 327 can be operable (e.g., usable, executable, etc.) to initiate, perform, complete, and/or otherwise facilitate one or more portions of any embodiment described and/or contemplated herein, such as, for example, one or more portions of the process flows 100 and/or 200 described herein and/or one or more portions of the process flows described in connection with FIGS. 4 and/or 5. For example, in some embodiments, the preapproval application 327 is operable to enroll the holder 308 in the overage service (e.g., via the electronic banking account 309) and/or to enable the holder 308 to preapprove (and/or otherwise consent to) one or more future overage transactions and/or overage fees associated with those future overage transactions. In some embodiments, the holder's 308 preapproval is valid only if a predetermined condition is met. For example, in some embodiments, the predetermined condition relates to the future overage transaction, such that the holder's 308 preapproval is valid only if the future overage transaction is initiated during a predetermined period of time. In some embodiments, the holder 308 selects the predetermined condition, but in other embodiments, the preapproval application 327 selects the predetermined condition for the holder 308, for example, when the holder 308 enrolls in the overage service.

In some embodiments, the preapproval application 327 is operable to prompt the holder 308, via the user interface 329, to enroll in the overage service, agree to one or more terms of the overage service, and/or select one or more predetermined conditions. Additionally or alternatively, in some embodiments, the preapproval application 327 is operable to prompt, via the user interface 329, the holder 308 to consent to a future overage, to incurring an overage fee associated with that future overage, to using an overage service to cover that future overage, and/or to one or more terms of an overage service. In some of these embodiments, the preapproval application 327 is also operable to receive, via the user interface 329, the holder's 302 consent to the future overage, to incurring an overage fee associated with the future overage, to using the overage service to cover the future overage, and/or to the one or more terms of the overage service. In some embodiments, where the overage preapproval machine 320 includes and/or is embodied as a personal computer, the preapproval application 327 is configured to execute on the personal computer, and in some embodiments, the preapproval application 327 is embodied as a web browser (i.e., for navigating the Internet, for accessing online banking accounts, etc.).

In some embodiments, where the overage preapproval machine 320 is also a transaction machine, the preapproval application 327 is operable to receive transaction information associated with a transaction. In some embodiments, the preapproval application 327 is operable to determine, based at least partially on transaction information, that an account (e.g., the account 307, etc.) will incur an overage as a result of a transaction. In some embodiments, the preapproval application 327 is operable to determine whether one or more predetermined conditions are met and/or whether the holder's 308 consent is valid. In still further embodiments, the preapproval application 327 is operable to authorize one or more transactions, for example, based at least partially on determining that a predetermined condition is met, on determining that the holder's 308 consent is met, and/or on receiving a holder's consent (e.g., to authorize the transaction). In some embodiments, the preapproval application 327 is operable to complete one or more transactions at the preapproval machine 320 (e.g., complete a purchase transaction, dispense cash, accept a check for deposit, etc.).

In some embodiments, the preapproval application 327 is operable to enable the holder 308 and/or overage preapproval machine 320 to communicate with one or more other portions of the system 300, and/or vice versa. In some embodiments, the preapproval application 327 is additionally or alternatively operable to initiate, perform, complete, and/or otherwise facilitate one or more financial and/or non-financial transactions. In some embodiments, the preapproval application 327 includes one or more computer-executable program code portions for causing and/or instructing the processor 324 to perform one or more of the functions of the preapproval application 327 and/or overage preapproval machine 320 described and/or contemplated herein. In some embodiments, the preapproval application 327 includes and/or uses one or more network and/or system communication protocols.

In some embodiments, the overage preapproval machine 320 and/or the preapproval application 327 (and/or one or more other portions of the system 300) requires its users to authenticate themselves to the overage preapproval machine 320 before the overage preapproval machine 320 will initiate, perform, complete, and/or facilitate a transaction. For example, in some embodiments, the overage preapproval machine 320 (and/or the preapproval application 327) is configured to authenticate a machine user based at least partially on an ATM/debit/credit card, loyalty/rewards/club card, smart card, token (e.g., USB token, etc.), username/password, personal identification number (PIN), biometric information, and/or one or more other credentials that the user presents to the overage preapproval machine 320. Additionally or alternatively, in some embodiments, the overage preapproval machine 320 is configured to authenticate a user by using one-, two-, or multi-factor authentication. For example, in some embodiments, the overage preapproval machine 320 requires two-factor authentication, such that the holder 308 must provide a valid password and iris scan to authenticate the holder 308 to the overage preapproval machine 320.

As shown in FIG. 3, the overage preapproval machine 320 also includes the user interface 329. It will be understood that the user interface 329 (and any other user interface described and/or contemplated herein) can include and/or be embodied as one or more user interfaces. It will also be understood that, in some embodiments, the user interface 329 includes one or more user output devices for presenting information and/or one or more items to the overage preapproval machine user (e.g., the holder 308, etc.), such as, for example, one or more displays, speakers, receipt printers, dispensers (e.g., cash dispensers, ticket dispensers, merchandise dispensers, etc.), and/or the like. In some embodiments, the user interface 329 additionally or alternatively includes one or more user input devices, such as, for example, one or more buttons, keys, dials, levers, directional pads, joysticks, keyboards, mouses, accelerometers, controllers, microphones, touchpads, touchscreens, haptic interfaces, styluses, scanners, biometric readers, motion detectors, cameras, card readers (e.g., for reading the magnetic strip on magnetic cards such as ATM, debit, credit, and/or bank cards, etc.), deposit mechanisms (e.g., for depositing checks and/or cash, etc.), and/or the like for receiving information from one or more items and/or from the overage preapproval machine user (e.g., the holder 308, etc.). In some embodiments, the user interface 329 and/or the overage preapproval machine 320 includes one or more vaults, security sensors, locks, and/or anything else typically included in and/or near a transaction machine.

FIG. 3 also illustrates an authorization apparatus 330, in accordance with an embodiment of the present invention. The authorization apparatus 330 may include any computerized apparatus that can be configured to perform any one or more of the functions of the authorization apparatus 330 described and/or contemplated herein. It will also be understood that the authorization apparatus 330 can include and/or be embodied as any authorization apparatus described and/or contemplated herein. It will further be understood that the authorization apparatus 330 can initiate, perform, complete, and/or otherwise facilitate any transaction described and/or contemplated herein as being initiated, performed, and/or otherwise facilitated by an authorization apparatus. In some embodiments, the authorization apparatus 330 includes and/or is embodied as one or more servers, engines, mainframes, personal computers, ATMs, network devices, front end systems, back end systems, and/or the like. In some embodiments, such as the one illustrated in FIG. 3, the authorization apparatus 330 includes a communication interface 332, a processor 334, and a memory 336, which includes an authorization application 337 and an authorization datastore 338 stored therein. As shown, the communication interface 332 is operatively and selectively connected to the processor 334, which is operatively and selectively connected to the memory 336.

The authorization application 337 can be operable (e.g., usable, executable, etc.) to initiate, perform, complete, and/or otherwise facilitate any one or more portions of the process flows 100 and/or 200 described herein and/or one or more portions of the process flows described in connection with FIGS. 4 and/or 5. For example, in some embodiments, the authorization application 337 is operable to receive, via the user interface 329 of the overage preapproval machine 320, the holder's 308 consent to one or more future overages, where the holder's 308 consent is valid only if one or more predetermined conditions are met. As another example, in some embodiments, the authorization application 337 is operable to receive transaction information associated with a transaction, where the transaction involves the holder 308, the account 307, and/or one or more of the channels 301-306. As still another example, in some embodiments, the authorization application 337 is operable to determine, based at least partially on transaction information, that an account (e.g., the account 307) will incur an overage as a result of a transaction. As another example, in some embodiments, the authorization application 337 is operable to determine whether one or more predetermined conditions are met and/or whether the holder's 308 consent is valid. As still another example, in some embodiments, the authorization application 337 is operable to authorize and/or complete one or more transactions. Also, in some embodiments, the authorization application 337 is further operable to prompt the holder 308 (e.g., via the user interface 329 of the overage preapproval machine 320, via the user interface of the mobile phone 305, during the overage transaction, etc.) to agree to the one or more terms of an overage service and/or to one or more predetermined conditions. In some embodiments, the authorization application 337 is operable to perform one or more of these (and/or other) functions, such that a financial institution may comply with one or more overage regulation requirements (e.g., Regulation E in the United States, etc.).

In some embodiments, the authorization application 337 is operable to enable the authorization apparatus 330 to communicate with one or more other portions of the system 300, such as, for example, the authorization datastore 338, the mobile device 305, and/or the overage preapproval machine 320, and/or vice versa. In addition, in some embodiments, the authorization application 337 is operable to initiate, perform, complete, and/or otherwise facilitate one or more financial and/or non-financial transactions. In some embodiments, the authorization application 337 includes one or more computer-executable program code portions for causing and/or instructing the processor 334 to perform one or more of the functions of the authorization application 337 and/or the authorization apparatus 330 that are described and/or contemplated herein. In some embodiments, the authorization application 337 includes and/or uses one or more network and/or system communication protocols.

In addition to the authorization application 337, the memory 336 also includes the authorization datastore 338. It will be understood that the authorization datastore 338 can be configured to store any type and/or amount of information. For example, in some embodiments, the authorization datastore 338 includes information associated with one or more overage preapproval machines, overage preapproval machine users, transaction machines, transaction machine users, transactions, overages, predetermined conditions, financial accounts, electronic banking accounts, mobile phones, overage services, authorization requests, overage regulations, and/or the like. In some embodiments, the authorization datastore 338 may also store any information related to providing an overage service subject to one or more predetermined conditions. In some embodiments, the authorization datastore 338 additionally or alternatively stores information associated with electronic banking and/or electronic banking accounts.

In accordance with some embodiments, the authorization datastore 338 may include any one or more storage devices, including, but not limited to, datastores, databases, and/or any of the other storage devices typically associated with a computer system. It will also be understood that the authorization datastore 338 may store information in any known way, such as, for example, by using one or more computer codes and/or languages, alphanumeric character strings, data sets, figures, tables, charts, links, documents, and/or the like. Further, in some embodiments, the authorization datastore 338 includes information associated with one or more applications, such as, for example, the authorization application 337 and/or the preapproval application 327. In some embodiments, the authorization datastore 338 provides a real-time or near real-time representation of the information stored therein, so that, for example, when the processor 334 accesses the authorization datastore 338, the information stored therein is current or nearly current. Although not shown, in some embodiments, the overage preapproval machine 320 includes a preapproval datastore that is configured to store any information associated with the overage preapproval machine 320, the preapproval application 327, and/or the like. It will be understood that the preapproval datastore can store information in any known way, can include information associated with anything shown in FIG. 3, and/or can be configured similar to the authorization datastore 338.

The embodiment illustrated in FIG. 3 is exemplary and other embodiments may vary. For example, in some embodiments, some or all of the portions of the system 300 are combined into a single portion. Specifically, in some embodiments, the overage preapproval machine 320 and the authorization apparatus 330 are combined into a single preapproval and authorization apparatus that is configured to perform all of the same functions of those separate portions as described and/or contemplated herein. As another example, in some embodments, the overage preapproval machine 320 and the mobile phone 305 (or the ATM 304) are combined into a single mobile phone (or ATM) that is configured to perform all of the same functions of those separate portions as described and/or contemplated herein. Likewise, in some embodiments, some or all of the portions of the system 300 are separated into two or more distinct portions. In addition, the various portions of the system 300 may be maintained by the same or separate parties.

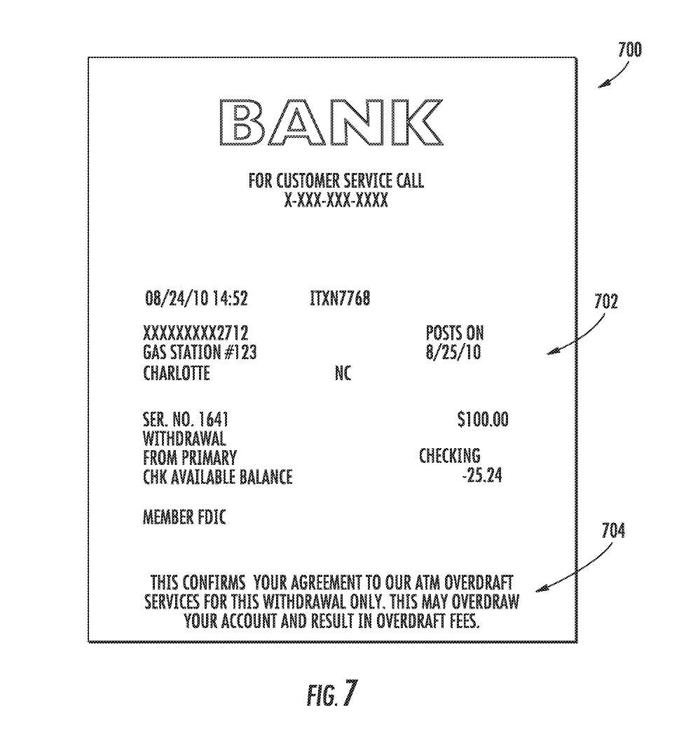

The system 300 and/or one or more portions of the system 300 may include and/or implement any embodiment of the present invention described and/or contemplated herein. For example, in some embodiments, the system 300 (and/or one or more portions of the system 300) is configured to implement any one or more embodiments of the process flow 100 described and/or contemplated herein in connection with FIG. 1, any one or more embodiments of the process flow 200 described and/or contemplated herein in connection with FIG. 2, any one or more embodiments of the process flow described and/or contemplated herein in connection with FIG. 4, and/or any one or more of embodiments of the process flow described and/or contemplated herein in connection with FIG. 5.

As a specific example, in accordance with an embodiment of the present invention, the authorization apparatus 330 is configured to: (a) receive, from the holder 308 of the account 307 and via the overage preapproval machine 320, consent to a future overage, where the future overage is a result of a future overage transaction involving the account 307, and where the consent is only valid if a predetermined condition is met, as represented by block 110 in FIG. 1; (b) receive transaction information associated with a transaction, where the transaction involves the account 307, the holder 308, and a transaction machine (e.g., any of the channels 301-306, etc.), and where the transaction was initiated after receiving the holder's 302 consent to the future overage, as represented by block 120; (c) determine, based at least partially on the transaction information, that the account 307 will incur an overage as a result of the transaction, as represented by block 130; (d) determine that the predetermined condition is met and/or that the holder's 308 consent is valid for (e.g., covers) the transaction (e.g., based at least partially on the transaction information), as represented by block 140; and (e) authorize the transaction based at least partially on receiving the holder's 308 consent, determining that the holder's 308 consent is valid for the transaction, and/or determining that the predetermined condition is met, as represented by block 150. In accordance with some embodiments, the overage preapproval machine 320, the authorization apparatus 330, and/or one or more of the channels 301-306 are each configured to send and/or receive one or more instructions to and/or from each other, such that an instruction sent, for example, from the overage preapproval machine 320 to the authorization apparatus 330 (and/or vice versa) can trigger the authorization apparatus 330 (and/or vice versa) to perform one or more portions of any one or more of the embodiments described and/or contemplated herein.

Referring now to FIG. 4, a mixed block and flow diagram of a system 400 is illustrated for providing an overdraft service subject to a predetermined time condition, in accordance with an exemplary embodiment of the present invention. It will be understood that the system 400 illustrated in FIG. 4 represents an example embodiment of the process flow 200 described in connection with FIG. 2. As shown, the system 400 includes a mobile phone 401 (e.g., the mobile phone 305, the overage preapproval machine 320, etc.), a POS device 403 (e.g., the POS device 303, etc.), and an authorization server 405 (e.g., the authorization apparatus 330, etc.). The mobile phone 401, POS device 403, and authorization server 405 may each include a communication interface, a user interface, a processor, a memory, an application, and/or a datastore, and those components may be operatively connected to each other.

In accordance with some embodiments, the mobile phone 401 and the POS device 403 are each operatively and selectively connected to the authorization server 405 via one or more networks. For example, in some embodiments, the mobile phone 401 is operatively connected to the authorization server 405 via one or more telephone networks, and/or the POS device 403 is operatively connected to the authorization server 405 via one or more payment networks. In this example embodiment, the mobile phone 401 and the POS device 403 are accessible to a customer of a financial institution. The customer is also a holder of the checking account mentioned in FIG. 4, the checking account is associated with the debit card mentioned in FIG. 4, and the financial institution maintains the checking account held by the customer. Also, it will be understood that, in this example embodiment, the customer and/or the checking account are enrolled in an overdraft service before the process flow represented by blocks 402-426 is performed. In addition, the mobile phone 401 is maintained by the customer, the POS device 403 is maintained by a merchant, and the authorization server 405 is maintained by the financial institution. Also, in this example embodiment, the portions of the process flow represented by blocks 402-426 all occur during a single day (e.g., in this example embodiment, the process flow occurs on “Monday”).

As represented by block 402, on Monday morning, the customer uses the mobile phone 401 to engage in a mobile phone transaction that results in his checking account having a low available balance. In other words, as a result of the mobile phone transaction, the available balance for the checking account falls below a predetermined threshold (e.g., $100, $20, etc.). In some embodiments, the customer and/or the financial institution may select, assign, set, and/or otherwise determine the predetermined threshold for the checking account, and this determining may occur, for example, when the customer opens the account and/or before the customer engages in the mobile phone transaction. Thereafter, as represented by block 404, the authorization server 405 determines that the available balance for the checking account has fallen below the predetermine threshold, and then the authorization server 405 generates and/or sends a low available balance alert to the customer via the mobile phone 401. In some embodiments, the low balance alert received by the mobile phone 401 is delivered visually to the customer via a display of the mobile phone 401 and/or audibly via a speaker of the mobile phone 401. For example, in some embodiments, the customer receives, via the mobile phone 401, an SMS message from the authorization server 405, where the SMS message indicates that the customer's available balance has fallen below the predetermined threshold.

In addition, as represented by block 406, the authorization server 405 also prompts the customer, via the mobile phone 401, to “consent for the day,” i.e., the customer is asked to preapprove any overdraft transaction involving his checking account that may occur later on Monday. In other words, the customer is asked to consent to the financial institution and/or the authorization server 405 using the overdraft service to complete one or more future overdraft transactions involving his checking account that may occur on Monday. Additionally or alternatively, in some embodiments, the customer also preapproves being charged an overdraft fee if his checking account engages in an overdraft transaction later on Monday and/or if his checking account remains overdrawn at the end of the day on Monday.

It will be understood that, in this example embodiment, the customer's consent is only valid for Monday. In other words, in this embodiment, if the customer engages in an overdraft transaction on Tuesday (e.g., the Tuesday immediately after the Monday referred to in FIG. 4), the customer's consent referred to in blocks 406 and 408 will not be valid for the Tuesday transaction, the customer cannot be charged an overdraft fee associated with the Tuesday transaction (e.g., in accordance with an overdraft regulation), and/or the Tuesday transaction will be declined (unless, of course, the customer provides additional consent to cover the Tuesday overdraft transaction). Also, although shown as different blocks 404 and 406, it will be understood that the low balance alert and the prompting the customer to consent for the day can be combined into a single communication that is sent from the authorization server 405 to the mobile phone 401 (e.g., via a telephone network). Also, for simplicity, the predetermined condition placed on the customer's consent (i.e., that the consent is only valid for the rest of the day on Monday) is sometimes referred to herein as the “predetermined time condition.”

After receiving the low balance alert and/or being prompted by the authorization server 405, the customer consents for the day via the mobile phone 401 (and/or via a telephone network), as represented by block 408. For example, in some embodiments, the customer uses one or more buttons, styluses, and/or other user input devices provided by the mobile phone 401 (and/or by an application executing on the mobile phone 401) to indicate his consent to future overdrafts involving his checking account that occur later on Monday. In some embodiments, by consenting for the day, the customer agrees to: (a) use the overdraft service to complete one or more overdraft transactions involving the checking account that occur later on Monday; (b) incur an overdraft fee for using the overdraft service later on Monday; (c) incur an overdraft fee if the checking account remains overdrawn at the end of the day on Monday; and/or (d) the one or more terms of the overdraft service if the service is used on Monday to complete an overdraft transaction involving the checking account.

After the customer consents for the day, the authorization server 405 stores the customer's preapproval and/or the one or more terms of the predetermined time condition in a datastore, as represented by block 410. In some embodiments, these items are stored in an account profile in the datastore, where the account profile is associated with the customer's account. In addition, on Monday afternoon, after the customer consents for the day, the customer swipes his checking account debit card at the POS device 403 to engage in a purchase transaction, as represented by block 412. Although not shown, in some embodiments, the POS device 403 may also authenticate the customer based at least partially on one or more credentials (e.g., PIN, etc.) the customer provides to the POS device 403. Next, as represented by block 414, the POS device 403 generates and/or sends an authorization request associated with the purchase transaction to the authorization server 405. In accordance with some embodiments, the authorization request includes information that, for example, identifies the customer, the checking account associated with the debit card, the amount of the transaction, the one or more goods and/or services involved in the transaction, and/or the like. As represented by block 416, the authorization server 405 then determines that the checking account will incur an overdraft as a result of the transaction.

After making the overdraft determination, the authorization server 405 determines that the customer is enrolled in the overdraft service provided by the financial institution, as represented by block 418. Thereafter, as represented by block 420, the authorization server 405 determines that the purchase transaction is an overdraft transaction that satisfies the customer's predetermined time condition. In other words, in some embodiments, the authorization server 405 determines that customer's consent referred to in block 406 is valid for the purchase transaction referred to in block 412 based at least partially on determining that the purchase transaction is an overdraft transaction that occurred on Monday after the customer provided his consent. In some embodiments, the authorization server 405 makes the condition determination based at least partially on comparing the transaction information associated with the purchase transaction to the one or more terms of the customer's predetermined time condition stored in the datastore. Thereafter, the authorization server 405 approves the authorization request, as represented by block 422, based at least partially on determining that the purchase transaction satisfied the predetermined time condition, on determining that the customer's consent is valid for the transaction, and/or on determining that the customer consented for the day. Thereafter, as represented by block 424, the transaction is completed at the POS device 403. In addition, as represented by block 426, the authorization server 405 charges the customer (and/or the customer's checking account) an overdraft fee for overdrafting his checking account. Although not shown, the authorization server 405 can be additionally or alternatively configured to charge the customer an overdraft fee if the customer's checking account remains overdrawn at the end of the day on Monday.

Of course, the embodiment illustrated in FIG. 4 is merely exemplary and other embodiments may vary without departing from the scope and spirit of the present invention. For example, in some embodiments, one or more portions of the process flow being performed by the authorization server 405 are performed instead by the POS device 403, or vice versa. As another example, in some alternative embodiments, instead of consenting for the day, the customer may preapprove only two overdraft transactions for a particular month, and the authorization server 405 may approve the authorization request referred to in block 422 based at least partially on determining that the purchase transaction referred to in block 412 constitutes the first overdraft transaction involving the checking account in that particular month. As another example, in some alternative embodiments of the present invention, instead of involving a debit card, a checking account, a debit card transaction, and/or an overdraft service, the process flow shown in FIG. 4 involves a credit card, a credit card account, a credit card transaction, and/or an over limit service.

Also, in some embodiments, one or more of the portions of the process flow represented by blocks 402-426 are triggered by one or more triggering events, which, in some embodiments, include the performance of one or more of the other portions of the process flow represented by blocks 402-426. Also, in some embodiments, the system 400 is configured to perform the entire process flow represented by blocks 402-426, from start to finish, within moments, seconds, and/or minutes. For example, in some embodiments, the authorization server 405 approves the authorization request within approximately 1-5 minutes of the authorization server 405 receiving the authorization request from the POS device 403. Further, it will be understood that one or more portions of the process flow represented by blocks 402-426 are configured to comply with one or more requirements of an overdraft regulation (e.g., Regulation E in the United States).

Referring now to FIG. 5, a mixed block and flow diagram of a system 500 is illustrated for providing an over limit service subject to a predetermined transaction amount condition, in accordance with an exemplary embodiment of the present invention. It will be understood that the system 500 illustrated in FIG. 5 represents an example embodiment of the process flow 200 described in connection with FIG. 2. As shown, the system 500 includes a personal computer 501, a POS device 503 (e.g., merchant terminal, etc.), and an authorization server 505 (e.g., the authorization apparatus 330, etc.). The personal computer 501, the POS device 503, and the authorization server 505 may each include a communication interface, a user interface, a processor, a memory, an application, and/or a datastore, and those components may be operatively connected to each other.

In accordance with some embodiments, the personal computer 501 and the POS device 503 are operatively and selectively connected to the authorization server 505 via one or more networks. For example, in some embodiments, the personal computer 501 is operatively connected to the authorization server 505 via the Internet, and/or the POS device 503 is operatively connected to the authorization server 505 via a payment network. In this example embodiment, the personal computer 501 and the POS device 503 are accessible to a customer of a financial institution. The customer is also a holder of the credit card account mentioned in FIG. 5, the credit card account is associated with the credit card mentioned in FIG. 5, and the financial institution maintains the credit card account held by the customer. It will be understood that, in this example embodiment, the personal computer 501 is maintained by the customer, the POS device 503 is maintained by a merchant, and the authorization server 505 is maintained by the financial institution.

As represented by block 502, the customer logs in to an online banking account accessible through the personal computer 501. In some embodiments, the online banking application authenticates the customer before providing the customer access to the online banking account. In some embodiments, the online banking application authenticates the customer based at least partially on one or more credentials provided by the customer to the application (e.g., username, password, account number, PIN, etc.). After logging in, the customer enrolls in an over limit service provided by the financial institution. During or after enrollment, the customer preapproves future over limit transactions that exceed $100. In other words, the customer consents to the financial institution and/or the authorization server 505 using the over limit service to complete one or more future over limit transactions involving his checking account that have a transaction amount greater than $100. Additionally or alternatively, in some embodiments, the customer also preapproves being charged an over limit fee if his credit card account engages in a future over limit transaction that exceeds $100 and/or if his credit card account remains over limit at the end of the day in which the future over limit transaction occurred.

It will be understood that, in this example embodiment, the customer's preapproval is only valid for future over limit transactions that exceed $100. In other words, in this embodiment, if the customer engages in a future over limit transaction having a transaction amount of $10, the customer's preapproval referred to in block 506 will not be valid for the $10 transaction, the customer cannot be charged an over limit fee associated with the $10 transaction (e.g., in accordance with an over limit regulation), and/or the $10 transaction will be declined (unless, of course, the customer provides additional preapproval and/or approval to cover the $10 over limit transaction). Also, for simplicity, the predetermined condition placed on the customer's preapproval (i.e., that the preapproval only covers future over limit transactions that exceed $100) is sometimes referred to herein as the “predetermined transaction amount condition.”

After the customer enrolls in the over limit service and indicates his preapproval, the authorization server 505 stores the customer's preapproval and/or the one or more terms of the predetermined transaction amount condition in a datastore, as represented by block 508. In addition, after enrolling in the over limit service, the customer arrives at the POS device 503 to engage in a credit card transaction. As represented by block 510, the customer swipes his credit card at the POS device 503 to initiate a purchase transaction having a $250 transaction amount. Thereafter, the POS device 503 generates and/or sends an authorization request associated with the transaction to the authorization server 505, as represented by block 512. In accordance with some embodiments, the authorization request includes information that, for example, identifies the customer, the credit card account associated with the customer, the amount of the transaction, the one or more goods and/or services involved in the transaction, and/or the like. After receiving the authorization request, the authorization server 505 determines that credit card account involved in the transaction will go over limit as a result of the transaction, as represented by block 510. In other words, in some embodiments, the credit card balance will exceed the credit limit for the credit card if the transaction is completed.

After making the over limit determination, the authorization server 505 determines that the customer is enrolled in the over limit service provided by the financial institution, as represented by block 516. Thereafter, as represented by block 518, the authorization server 505 determines that the purchase transaction is an over limit transaction that satisfies the customer's predetermined transaction amount condition. In other words, in some embodiments, the authorization server 505 determines that customer's preapproval referred to in block 506 covers the purchase transaction referred to in block 510 based at least partially on determining that the purchase transaction is an over limit transaction having a transaction amount greater than $100 (i.e., $250 is greater than $100). In some embodiments, the authorization server 505 makes the condition determination based at least partially on comparing the transaction information associated with the purchase transaction to the one or more terms of the customer's predetermined transaction amount condition stored in the datastore. Thereafter, the authorization server 505 approves the authorization request, as represented by block 520, based at least partially on determining that the purchase transaction satisfies the predetermined transaction amount condition, on determining that the customer's preapproval covers the purchase transaction, and/or on determining that the customer indicated his preapproval for future over limit transactions that exceed $100. Thereafter, as represented by block 522, the transaction is completed at the POS device 503. In addition, as represented by block 524, the authorization server 505 charges the customer (and/or the customer's credit card account) an over limit fee for going over limit on his credit card account. Although not shown, the authorization server 505 can be additionally or alternatively configured to charge the customer an over limit fee if the customer's credit card account remains over limit at the end of the day in which the transaction occurred.

Of course, the embodiment illustrated in FIG. 5 is merely exemplary and other embodiments may vary without departing from the scope and spirit of the present invention. For example, in some embodiments, one or more portions of the process flow being performed by the authorization server 505 are performed instead by the POS device 503, or vice versa. As another example, in some alternative embodiments of the present invention, instead of involving a credit card account and/or an over limit service, the process flow 500 shown in FIG. 5 involves a deposit account, overdraft, and/or an overdraft service. As yet another example, in some alternative embodiments, instead of the predetermined condition being tied to the transaction amount of the over limit transaction, the predetermined condition is additionally or alternatively tied to the amount the account goes over limit as a result of the transaction (e.g., the customer's consent may be valid only for over limit transactions that result in his credit card account being over limit by $50 or more, etc.).

Also, in some embodiments, one or more of the portions of the process flow represented by blocks 502-524 are triggered by one or more triggering events, which, in some embodiments, include the performance of one or more of the other portions of the process flow represented by blocks 502-524. Also, in some embodiments, the system 500 is configured to perform the entire process flow represented by blocks 502-524, from start to finish, within moments, seconds, and/or minutes. For example, in some embodiments, the customer consents to the over limit amount within approximately 1-5 minutes of the authorization server 505 receiving the authorization request from the POS device 501. Further, it will be understood that one or more portions of the process flow represented by blocks 502-524 are configured to comply with one or more requirements of an over limit regulation (e.g., the CARD Act in the United States, etc.).

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, etc.), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatuses and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s)

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A method comprising:
receiving, from a holder of an account, consent to a future overage, wherein the future overage is a result of a future overage transaction involving the account, and wherein the consent is valid only if a predetermined condition is met;
receiving transaction information associated with a transaction, wherein the transaction involves the account, and wherein the transaction was initiated after the receiving the consent;
determining, using a processor and based at least partially on the transaction information, that the account will incur an overage as a result of the transaction;
determining that the predetermined condition is met; and
authorizing the transaction based at least partially on the determining that the predetermined condition is met.

2. The method of claim 1, wherein the predetermined condition relates to the future overage transaction, such that the consent is valid only if the future overage transaction is initiated during a predetermined period of time, and wherein the transaction is initiated during the predetermined period of time.

3. The method of claim 1, wherein the predetermined condition relates to the future overage transaction, such that the consent is valid only for a predetermined number of future overage transactions involving the account, and wherein the transaction constitutes an overage transaction that is less than the predetermined number.

4. The method of claim 1, wherein the predetermined condition relates to the future overage, such that the consent is valid only if the amount of the future overage is greater than a predetermined amount, and wherein the amount of the overage is greater than the predetermined amount.

5. The method of claim 1, wherein the predetermined condition relates to the future overage transaction, such that the consent is valid only if the transaction amount of the future overage transaction is greater than a predetermined amount, and wherein the transaction amount of the transaction is greater than the predetermined amount.

6. The method of claim 1, wherein the predetermined condition relates to the future overage transaction, such that the consent is valid only if the future overage transaction involves a predetermined type of merchant, and wherein the transaction involves the predetermined type of merchant.

7. The method of claim 1, wherein the predetermined condition relates to the future overage transaction, such that the consent is valid only if the future overage transaction involves a predetermined type of channel, and wherein the transaction involves the predetermined type of channel.

8. The method of claim 1, wherein the predetermined condition relates to the future overage transaction, such that the consent is valid only if the future overage transaction involves a merchant associated with a predetermined merchant category code, and wherein the transaction involves a merchant associated with the predetermined merchant category code.

9. The method of claim 1, wherein the predetermined condition relates to the type of the future overage transaction, such that the consent is valid only if the future overage transaction comprises a predetermined transaction type, and wherein the transaction comprises the predetermined transaction type.

10. The method of claim 1, further comprising:
prompting the holder to select the predetermined condition; and
receiving information indicating that the holder has selected the predetermined condition, wherein the receiving the information occurs before the receiving the transaction information.

11. The method of claim 1, further comprising:
determining that the available balance or available credit for the account has fallen below a predetermined threshold; and
prompting the holder to consent to the future overage based at least partially on the determining that the available balance or available credit has fallen below the predetermined threshold, wherein the prompting the holder occurs before the receiving the consent.

12. The method of claim 1, further comprising:
assessing the account an overage fee based at least partially on determining that the account settled negative at the end of the day in which the transaction occurred; or
determining not to assess the account an overage fee based at least partially on determining that the account settled non-negative at the end of the day in which the transaction occurred.

13. The method of claim 1, further comprising:
receiving, from a second holder of a second account, second consent to a second future overage, wherein the second future overage is a result of a second future overage transaction involving the second account, and wherein the second consent is valid only if a second predetermined condition is met;
receiving second transaction information associated with a second transaction, wherein the second transaction involves the second account, and wherein the second transaction was initiated after the receiving the second consent;
determining, based at least partially on the second transaction information, that the second account will incur a second overage as a result of the second transaction;
determining that the second predetermined condition is not met; and
declining the second transaction based at least partially on the determining that the second predetermined condition is not met.

14. The method of claim 1, further comprising:
storing information associated with the predetermined condition in an account profile associated with the account, wherein the account profile is stored in a datastore, and
wherein the determining that the predetermined condition is met is based at least partially on comparing the transaction information received to the information associated with the predetermined condition in the account profile.

15. An apparatus comprising:
a first communication interface configured to receive, from a holder of an account and via a telecommunications network, consent to a future overage, wherein the future overage is a result of a future overage transaction involving the account, and wherein the consent is valid only if a predetermined condition is met;
a second communication interface configured to receive, via a payment network, transaction information associated with a transaction, wherein the transaction involves the account, a transaction machine, and the holder of the account, and wherein the transaction was initiated after the first communication interface receives the consent; and
a processor operatively connected to the first communication interface and the second communication interface, and configured to:
determine, based at least partially on the transaction information, that the account will incur an overage as a result of the transaction;
determine that the predetermined condition is met; and
authorize the transaction based at least partially on the processor determining that the predetermined condition is met.

16. The apparatus of claim 15, wherein the telecommunications network is a telephone network.

17. The apparatus of claim 15, wherein the predetermined condition relates to the future overage transaction, such that the consent is valid only if the future overage transaction occurs during a predetermined period of time, and wherein the transaction occurs during the predetermined period of time.

18. The apparatus of claim 15, wherein the predetermined condition relates to the future overage transaction, such that the consent is valid only for a predetermined number of future overage transactions involving the account, and wherein the transaction constitutes an overage transaction that is less than the predetermined number.

19. The apparatus of claim 15, wherein the predetermined condition relates to the future overage, such that the consent is valid only if the amount of the future overage is greater than a predetermined amount, and wherein the amount of the overage is greater than the predetermined amount.

20. The apparatus of claim 15, wherein the predetermined condition relates to the future overage transaction, such that the consent is valid only if the transaction amount of the future overage transaction is greater than a predetermined amount, and wherein the transaction amount of the transaction is greater than the predetermined amount.

21. The apparatus of claim 15, wherein the predetermined condition relates to the future overage transaction, such that the consent is valid only if the future overage transaction involves a predetermined type of merchant, and wherein the transaction involves the predetermined type of merchant.

22. The apparatus of claim 15, wherein the predetermined condition relates to the future overage transaction, such that the consent is valid only if the future overage transaction involves a predetermined type of channel, and wherein the transaction involves the predetermined type of channel.

23. The apparatus of claim 15, wherein the predetermined condition relates to the future overage transaction, such that the consent is valid only if the future overage transaction involves a merchant associated with a predetermined merchant category code, and wherein the transaction involves a merchant associated with the predetermined merchant category code.

24. The apparatus of claim 15, wherein the predetermined condition relates to the type of the future overage transaction, such that the consent is valid only if the future overage transaction comprises a predetermined transaction type, and wherein the transaction comprises the predetermined transaction type.

25. The apparatus of claim 15, wherein the first communication interface is further configured to:
prompt the holder, via the telecommunications network, to select the predetermined condition; and
receive information, via the telecommunications network, that indicates that the holder selected the predetermined condition, wherein the first communication interface receives the information before the second communication interface receives the transaction information.

26. The apparatus of claim 15, wherein the processor is further configured to:
determine that the available balance or available credit for the account has fallen below a predetermined threshold; and
instruct the first communication interface to prompt the holder, via the telecommunications network, to consent to the future overage based at least partially on the processor determining that the available balance or available credit has fallen below the predetermined threshold, wherein the processor instructs the first communication interface to prompt the holder before the first communication interface receives the consent.

27. The apparatus of claim 15, wherein the processor is further configured to assess the account an overage fee based at least partially on processor determining that the account settled negative at the end of the day in which the transaction occurred.

28. The apparatus of claim 15,
wherein the first communication interface is configured to receive, from a second holder of a second account and via the telecommunications network, second consent to a second future overage, wherein the second future overage is a result of a second future overage transaction involving the second account, and wherein the second consent is valid only if a second predetermined condition is met,
wherein the second communication interface is configured to receive, via the payment network, second transaction information associated with a second transaction, wherein the second transaction involves the second account, a second transaction machine, and the second holder of the second account, and wherein the second transaction was initiated after the first communication interface receives the second consent,
wherein the processor is further configured to:
determine, based at least partially on the second transaction information, that the second account will incur a second overage as a result of the second transaction;
determine that the second predetermined condition is not met; and
decline the second transaction based at least partially on the processor determining that the second predetermined condition is not met.

29. The apparatus of claim 15, further comprising:
a memory device operatively connected to the processor and configured to:
store information associated with the predetermined condition in an account profile associated with the account, and
wherein the processor determines that the predetermined condition is met is based at least partially on comparing the transaction information received to the information associated with the predetermined condition in the memory device.

30. A computer program product comprising a non-transitory computer-readable medium, wherein the non-transitory computer-readable medium comprises one or more computer-executable program code portions that, when executed by a computer, cause the computer to:
receive, from a holder of an account, consent to a future overage, wherein the future overage is a result of a future overage transaction involving the account, and wherein the consent is valid only if a predetermined condition is met;
receive transaction information associated with a transaction, wherein the transaction involves the account, and wherein the transaction was initiated after the computer receives the consent;
determine, based at least partially on the transaction information, that the account does not have sufficient funds or credit to complete the transaction;
determine that the predetermined condition is met; and
provide funds or credit sufficient to complete the transaction based at least partially on the computer determining that the predetermined condition is met.

31. The computer program product of claim 30, wherein the predetermined condition is such that the consent is valid only if the future overage transaction occurs during a predetermined period of time, and wherein the transaction occurs during the predetermined period of time.

32. The computer program product of claim 30, wherein the predetermined condition is such that the consent is valid only for a predetermined number of future overage transactions involving the account, and wherein the transaction constitutes an overage transaction within the predetermined number.

33. The computer program product of claim 30, wherein the predetermined condition is such that the consent is valid only if the transaction amount of the future overage transaction is greater than a predetermined amount, and wherein the transaction amount of the transaction is greater than the predetermined amount.

34. The computer program product of claim 30, wherein the predetermined condition is such that the consent is valid only if the future overage transaction involves a merchant associated with a predetermined merchant category code, and wherein the transaction involves a merchant associated with the predetermined merchant category code.

35. The computer program product of claim 30, wherein the one or more computer-executable program code portions, when executed by the computer, cause the computer to:
prompt the holder to select the predetermined condition; and
receive information associated with the predetermined condition from the holder, wherein the receiving the information occurs before the receiving the transaction information.

36. The computer program product of claim 30, wherein the one or more computer-executable program code portions, when executed by the computer, cause the computer to:
determine that the available balance or available credit for the account has fallen below a predetermined threshold; and
prompt the holder to consent to the future overage based at least partially on the computer determining that the available balance or available credit has fallen below the predetermined threshold, wherein the computer prompts the holder before the computer receives the consent.

37. The computer program product of claim 30, wherein the one or more computer-executable program code portions, when executed by the computer, cause the computer to:
provide the funds or credit sufficient to complete the transaction by providing only the minimum amount of funds or credit needed to complete the transaction.

38. The computer program product of claim 30, wherein the one or more computer-executable program code portions, when executed by the computer, cause the computer to:
provide the funds or credit sufficient to complete the transaction by crediting the account with the funds or the credit sufficient to complete the transaction.

39. The computer program product of claim 30, wherein the transaction involves a counterparty, and wherein the one or more computer-executable program code portions, when executed by the computer, cause the computer to:
provide the funds or credit sufficient to complete the transaction by providing the counterparty with the funds or credit sufficient to complete the transaction.

40. A method comprising:
receiving, from a holder of an account, preapproval to use an overage service to complete one or more future overage transactions, wherein the one or more future overage transactions involve the account and occur during a predetermined period of time;
receiving transaction information associated with a transaction, wherein the transaction involves the account, and wherein the transaction was initiated after the receiving the preapproval;
determining, using a processor and based at least partially on the transaction information, that the account does not have sufficient funds or credit to complete the transaction;
determining that the holder's preapproval covers the transaction based at least partially on determining that the transaction has occurred during the predetermined period of time; and
using an overage service to complete the transaction based at least partially on the determining that the holder's preapproval covers the transaction.

41. The method of claim 40, wherein the predetermined period of time comprises the period of time after the holder gave his preapproval and before the end of the day in which the holder gave his preapproval.

42. The method of claim 40, wherein the holder's preapproval covers only a predetermined number of future overage transactions involving the account, and wherein the transaction constitutes an overage transaction that is less than the predetermined number.

43. The method of claim 40, wherein the holder's preapproval covers the one or more future overage transactions only if each of the one or more future overage transactions has a transaction amount greater than a predetermined amount, and wherein the transaction amount of the transaction is greater than the predetermined amount.

44. The method of claim 40, wherein the holder's preapproval covers the one or more future overage transactions only if each of the one or more future overage transactions involves a predetermined type of merchant, and wherein the transaction involves the predetermined type of merchant.

45. The method of claim 40, wherein the holder's preapproval covers the one or more future overage transactions only if each of the one or more future overage transactions comprises a predetermined transaction type, and wherein the transaction comprises the predetermined transaction type.

46. The method of claim 40, further comprising:
prompting the holder to select one or more terms of the holder's preapproval; and
receiving information indicating that the holder has selected one or more terms of the holder's preapproval, wherein the receiving the information occurs before the receiving the transaction information.

47. The method of claim 40, further comprising:
determining that the available balance or available credit for the account has fallen below a predetermined threshold; and
prompting the holder to preapprove using an overage service to complete the one or more future overage transactions, wherein the prompting the holder occurs before the receiving the holder's preapproval.
